(19) United States
(12) Patent Application Publication
(10) Pub. No.: US 2026/0176043 A1
(43) Pub. Date: Jun. 25, 2026

(54) BIODEGRADABLE MATERIAL

(71) Applicant: KELP INDUSTRIES LTD, Bristol (GB)

(72) Inventors: Stefanie FEDERLE, Bath (GB); Christopher CHUCK, Bristol (GB); Marco PICCINI, Bath (GB); Edward JONES, Bristol (GB); Julia MAXWELL

(73) Assignee: KELP INDUSTRIES LTD, Bristol (GB)

(21) Appl. No.: 19/127,459

(22) PCT Filed: Dec. 1, 2023
(86) PCT No.: PCT/GB2023/053108

§ 371 Date: May 6, 2025

(30) Foreign Application Priority Data
Dec. 1, 2022 (GB) 2218089.7

(51) Int. Cl. B65D 65/42; B65D 65/46; C09D 101/02; C09D 103/02; C09D 105/12

(52) U.S. Cl. CPC B65D 65/42; B65D 65/466; C09D 101/02; C09D 103/02; C09D 105/12

(57) ABSTRACT

The present invention provides materials and composite materials comprising layer (A) comprising afirst polysaccharide which has been derivatised to comprise fatty acid ester moieties. Also provided are substrates coated with the material and composite material, and processes for preparing the material, composite material and coated substrate.

The present invention relates to a biodegradable material, of particular use as a packaging material or as a coating for a packaging material. Also provided are processes for preparing the material, and substrates coated with the material.

### BACKGROUND OF INVENTION

Traditional polymer materials of use in packaging are typically prepared using petroleum-based starting materials, which provide materials such as films with suitable structural and barrier properties. PET (polyethylene terephthalate) is a thermoplastic polymer used in various food and drink containers, including meat trays, and is currently formed from ethylene glycol and dimethyl terephthalate. Ethylene glycol is made from ethene found in natural gas, and dimethyl terephthalate is produced from para-xylene, which is itself derived from crude oil.

LDPE (low-density polyethylene) and PP (polypropylene) are thermoplastics also used in packaging applications, and are made from ethylene and propylene, respectively, both of which are formed by steam cracking of hydrocarbons.

The use of such materials is not sustainable in the long term because of the finite nature of fossil fuel supplies, and associated environmental concerns due to the materials being non-biodegradable or breaking down to more microplastic particles. Biopolymer alternatives to petroleum-based starting materials are attractive from a sustainability and environmental perspective, but tend to lack the required structural and barrier properties to be of use as packaging materials, particular packaging for food.

Biopolymers based on polysaccharides are particularly attractive due the abundance of polysaccharide-based materials in nature, and seaweed in particular has been recognized as a sustainable feedstock. However, due to their hydrophilic nature, use as a direct replacement for petroleum-derived plastics, which demonstrate highly water-resistant properties, is not attainable.

A range of polysaccharide-based materials, such as starch mixtures, agar mixtures, methylcellulose, cellophane, sodium alginate and pectin, and their application in food packaging has been reported. However, while the oxygen barrier of the polysaccharide materials was sufficient to increase food shelf life, the materials exhibited high water vapour permeability rates and poor water resistance, as described in Cazón et al. (2017), Kibar (2017) and Diaz-Montez (2022).

Ways to improve the water resistance ability of polysaccharides and other biopolymers through addition of hydrophobic ingredients (for example lipids, oils or waxes), incorporation of fillers, cross-linking or multilayer composite films formation have been reported. However, the obtained film properties were still not comparable with synthetic non-degradable or degradable counterparts in terms of water barrier properties, as described in Abdullah et al. (2022) Ghiasi et al. (2020) and Khalil et al. (2019).

In summary, although a number of sustainable materials have been developed, none have the required water barrier and oxygen barrier properties, while also being sufficiently biodegradable. Thus, there is a need to develop biopolymer materials to replace the use of petrochemical-based plastic materials, which derive from a sustainable source and are biodegradable, while also having the required structural and barrier properties.

### SUMMARY OF THE INVENTION

According to a first aspect of the present invention, there is provided a substrate with a surface having a coating comprising a material, wherein the material comprises:
a layer (A) comprising a polysaccharide which has been derivatised to comprise fatty acid ester moieties.

In another aspect of the invention, there is provided a composite material comprising:
at least one layer (A) comprising a first polysaccharide which has been derivatised to comprise fatty acid ester moieties; and
at least one layer (B) comprising a second polysaccharide which is un-derivatised.

In one embodiment, at least a portion of (and preferably substantially all or all of) a surface of layer (A) is in contact with at least a portion of (and preferably substantially all or all of) a surface of a layer (B). In another embodiment, at least a portion of (and preferably substantially all or all of) a surface of layer (A) is bonded to at least a portion of (and preferably substantially all or all of) a surface of layer (B) using an adhesive.

In another aspect of the invention, there is provided a substrate with a surface having a coating comprising the composite material as described herein.

In aspects of the invention relating to a substrate with a surface having a coating, preferably the substrate is or comprises a packaging material, in particular for food, a beverage, a food supplement, a vitamin, a personal hygiene product, a cosmetic product, a product containing a therapeutic agent or a cleaning product.

Embodiments and preferences described below with respect to the composite material apply equally to individual materials/layers (A) and (B), to the substrate having a coating comprising the material or composite material, to the processes for preparing the material or composite material, and to the processes for preparing a substrate having a coating, wherein the coating comprises a material or a composite material as defined herein.

### BRIEF DESCRIPTION OF FIGURES

FIG. 1 illustrates various arrangements of composite materials containing layer (A) and layer (B), with and without an adhesive layer.

FIG. 2 illustrates various arrangements of composite materials containing different numbers of layers (A) and (B), with and without adhesive layers.

FIG. 3 illustrates various arrangements for layering a composite material containing layer (A) and layer (B) onto a substrate, with and without adhesive layers.

FIGS. 4 and 5 illustrate various arrangements where one or both sides of a substrate are coated with a material or a composite material, with and without adhesive layers.

FIG. 6 shows the results of a degradation study for layers (A) and (B) (Example 11).

FIG. 7 shows the results of an anaerobic digestion study (Example 12).

FIG. 8 shows the FTIR spectrum of agar palmitate obtained as per Example 1, overlayed with spectra for agar and palmitic acid.

### DETAILED DESCRIPTION

The present invention relates to materials (including layered materials defined as composite materials) which have excellent water barrier properties while also being biodegradable. In certain embodiments, the materials also have excellent oxygen barrier properties.

The present inventors have developed improved methods for derivatising polysaccharides to contain fatty acid ester moieties by converting at least a proportion of the polar hydroxyl groups of the polysaccharide into long chain fatty acid esters. The present inventors have found that the resulting derivatised polysaccharides demonstrate excellent water barrier properties, and have great potential for use in packaging applications, as a material in their own right and also when layered or coated onto a substrate used in packaging, in particular for packaging food, beverages, food supplements, vitamins, personal hygiene products, cosmetic products, products containing active agents and cleaning products. The present inventors have also found that by layering these highly water-resistant functionalised polysaccharide materials with other unmodified polysaccharide materials that show good oxygen barrier properties, layered composite materials can be formed which exhibit both water and oxygen barrier properties, therefore have potential for use in packaging applications where both water and oxygen barrier characteristics are desirable. Advantageously, the materials of the present invention are biodegradable.

The materials of the invention have utility in their own right, particularly when in the form of a film, as a replacement for PET, LDPE and PP in packaging applications, but can also be used as coatings for substrates such as card, carton board and other paper materials, which provide additional mechanical support.

The material of the invention comprises a layer of polysaccharide which has been derivatised to comprise fatty acid ester moieties. This layer is described as layer (A), particularly in the context of the composite material, which comprises at least one layer (A) and at least one layer (B).

Unless indicated otherwise, references herein to “material” are intended to refer to both materials comprising individual layers (A) or (B), and to composite materials comprising both of layers (A) and (B).

Layer (A) is key component of the composite material of the invention, but also has utility in its own right as a film, or in particular as a coating for a substrate. Thus, in one embodiment is provided a substrate with a surface having a coating comprising a material, wherein the material comprises:
a layer (A) comprising a polysaccharide which has been derivatised to comprise fatty acid ester moieties.

Suitably, layer (A) is a single layer.

Layer (A) comprises a polysaccharide (also known as a first polysaccharide in the context of the composite material) which has been derivatised to comprise fatty acid ester moieties. In one embodiment, the polysaccharide (first polysaccharide) is selected from the group consisting of cellulose (including natural cellulose, microcrystalline cellulose and nanocellulose; and including derivatives thereof, such as methylcellulose, ethylcellulose, ethyl methyl cellulose, carboxymethylcellulose, carboxymethylhydroxypropylcellulose, hydroxyethylcellulose, hydroxypropylcellulose and hydroxypropylhydroxylethylcellulose), starch (including derivatives thereof such as hydroxyethyl starch and hydroxypropyl starch), agar, carrageenan, alginic acid, an alginate salt (e.g. sodium alginate, calcium alginate or potassium alginate), fucoidan, laminarin, agarose, agaropectin, ulvan, xanthan gum and pectin, and mixtures thereof. Carrageenan includes kappa, Iota and lambda forms, although suitably kappa or iota form is used. In one embodiment, the polysaccharide (first polysaccharide) is derived from seaweed and is selected from the group consisting of agar, carrageenan, alginic acid, an alginate salt (e.g. sodium alginate, calcium alginate or potassium alginate), fucoidan, laminarin, agarose, agaropectin and ulvan. In a preferred embodiment, the first polysaccharide is selected from the group consisting of cellulose, starch and agar. In one embodiment, the polysaccharide (first polysaccharide) is cellulose or starch. In another embodiment, the polysaccharide (first polysaccharide) is agar.

The polysaccharide (first polysaccharide) has been derivatised to comprise fatty acid ester moieties. The fatty acid ester moieties are typically formed by reacting the polysaccharide (first polysaccharide) with a fatty acid derivative. For example, an esterification reaction between at least a proportion of the hydroxyl groups on the polysaccharide (first polysaccharide) with a reactive fatty acid derivative (e.g. an activated fatty acid compound), such as an acyl chloride or anhydride. Alternatively, the fatty acid ester moieties can be formed by reacting the polysaccharide (first polysaccharide) with a fatty acid or fatty acid ester in the presence of a coupling reagent/activator. Suitable coupling reagents/activators include EDCI (1-ethyl-3-(3-dimethylaminopropyl)carbodiimide), N,N′-dicyclohexylcarbodiimide, p-toluenesulfonyl chloride, methanesulfonyl chloride, 1,1′-carbonyldiimidazole, N,N′-diisopropylcarbodiimide, oxalyl chloride, thionyl chloride, acetic anhydride, trifluoroacetic anhydride, trifluoromethanesulfonyl chloride or any combination thereof. The esterification reaction can further comprise a base such as triethylamine, pyridine, 4-dimethylamine pyridine (DMAP) or imidazole. Suitable solvents for the esterification reaction include dimethylacetamide, dimethylformamide, formamide, toluene, dimethylsulfoxide, pyridine, chloroform, dichloromethane, dimethylacetamide/lithium chloride, imidazole, or any combination thereof. Thus, in the context of the present invention “fatty acid derivative” encompasses a reactive fatty acid derivative (also known as activated fatty acid compound), a fatty acid, and a fatty acid ester.

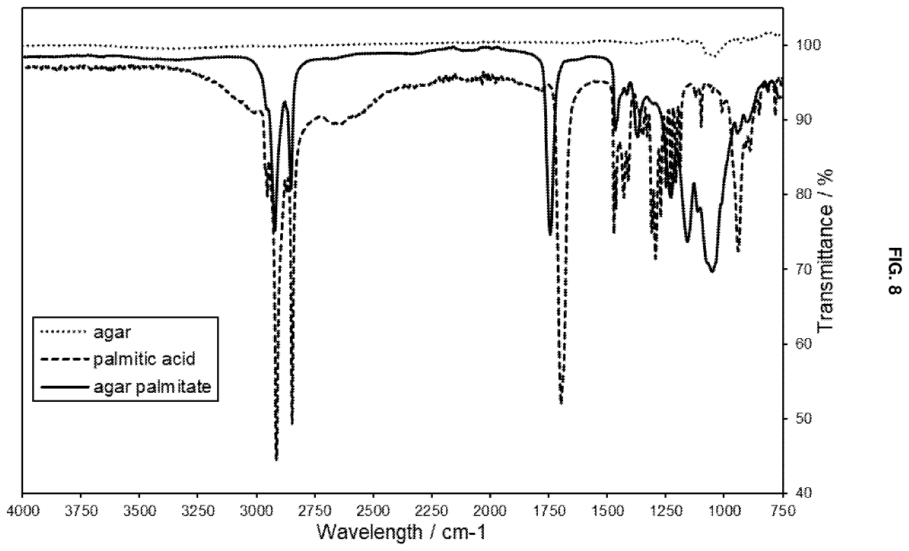

Such derivatisation methods are known in the art and described in US2,211,338A, CA2087488A1, US5,589,577A and US2009/0299053A1 all of which are incorporated herein by reference in their entirety. Earlier applications filed by the present inventors GB2203196.7 and GB2206804.3 describe methods for preparing a fatty acid derivative of a polysaccharide derived from seaweed, and are incorporated herein by reference in their entirety. An exemplary method for preparing a fatty acid ester functionalised polysaccharide (first polysaccharide) using a fatty acid acyl chloride is described in General Method A. Example 1 describes the preparation of agar functionalised with palmitic acid ester moieties, and the FTIR of the resulting derivatised polysaccharide is shown in FIG. 8.

In one embodiment, the polysaccharide (first polysaccharide) is functionalised with no more than 7 molar equivalents per repeat unit, preferably no more than 5 molar equivalents, of fatty acid derivative. In one embodiment, the polysaccharide (first polysaccharide) is functionalised with between 1 and 7 molar equivalents, preferably between 1 and 5 molar equivalents, preferably between 3 and 5 molar equivalents of fatty acid derivative. In a preferred embodiment, the fatty acid ester moieties are unbranched. In a preferred embodiment, the fatty acid ester moieties are saturated.

In one embodiment, the fatty acid ester moieties are of formula: —C(O)O(CH₂)₁₀₋₂₀CH₃, for example —C(O)O(CH₂)₁₀CH₃ (“C12” e.g. derived from lauric acid), —C(O)O(CH₂)₁₁CH₃, —C(O)O(CH₂)₁₂CH₃ (“C14” e.g. derived from myristic acid), —C(O)O(CH₂)₁₃CH₃, —C(O)O(CH₂)₁₄CH₃ (“C16” e.g. derived from palmitic acid), —C(O)O(CH₂)₁₅CH₃, —C(O)O(CH₂)₁₆CH₃ (“C18” e.g. derived from stearic acid), —C(O)O(CH₂)₁₇CH₃, —C(O)O(CH₂)₁₈CH₃ (“C20” e.g. derived from arachidic acid), —C(O)O(CH₂)₁₉CH₃ or —C(O)O(CH₂)₂₀CH₃ (“C22” e.g. derived from behenic acid). In particular, the fatty acid ester moieties are of formula —C(O)O(CH₂)₁₄CH₃ (“C16” e.g. derived from palmitic acid) or —C(O)O(CH₂)₁₅CH₃ or —C(O)O(CH₂)₁₆CH₃ (“C18” e.g. derived from stearic acid).

In one embodiment, the polysaccharide (first polysaccharide) is derivatised using an activated fatty acid of formula CH₃(CH₂)₁₀₋₁₈C(O)LG wherein LG is a leaving group, for example CH₃(CH₂)₁₀C(O)LG (activated lauric acid), CH₃(CH₂)₁₁C(O)LG, CH₃(CH₂)₁₂C(O)LG (activated myristic acid), CH₃(CH₂)₁₃C(O)LG, CH₃(CH₂)₁₄C(O)LG (activated palmitic acid), CH₃(CH₂)₁₅C(O)LG, CH₃(CH₂)₁₆C(O)LG (activated stearic acid), CH₃(CH₂)₁₇C(O)LG or CH₃(CH₂)₁₅C(O)LG (activated arachidic acid).

Layer (A) may also contain one or more additives in order to modify the structural or functional properties of the layer. In one embodiment, layer (A) comprises an additive selected from the group consisting of a plasticiser, a filler, a surfactant and an antioxidant, or a mixture thereof.

Suitable plasticisers include a vegetable oil (such as sunflower oil, palm oil, rapeseed oil, coconut oil, linseed oil, castor oil, peanut oil, tung oil or soybean oil) or a derivative thereof (such as epoxidized linseed oil, epoxidized tung oil, epoxidized castor oil, acetylated castor oil, epoxidized soybean oil, an epoxidized soybean oil fatty ester or methyl epoxy soyate), diisononyl-phthalate, mineral oil, limonene, tributyl citrate, diethyl adipate, dibutyl sebacate, acetyl tributyl citrate, triethyl citrate, glycerol, glycerol triacetate, bis(2-ethylhexyl)adipate, glycerol diacetate, poly(ethylene glycol) monolaurate, poly(ethyleneglycol), 1,4-butanediol, dimethyl phthalate, diethyl phthalate, di-(2-ethylhexyl)phthalate, di-isodecyl phthalate, or any combination thereof. Preferred plasticisers are vegetable oils (such as sunflower oil, palm oil, rapeseed oil, coconut oil, linseed oil, castor oil, peanut oil, tung oil or soybean oil) and derivatives thereof (such as epoxidized linseed oil, epoxidized tung oil, epoxidized castor oil, acetylated castor oil, epoxidized soybean oil, an epoxidized soybean oil fatty ester or methyl epoxy soyate). In one embodiment, the plasticiser is soybean oil. Suitably, when present, the plasticiser is present in an amount between about 1 wt. % and about 80 wt. %, such as between about 1 wt. % and about 50 wt. %, between about 1 wt. % and about 25 wt. %, between about 1 wt. % and about 10 wt. %, between about 2 wt. % and about 8 wt. %, such as about 5 wt. % (wherein the wt. % refers to the weight relative to the total weight of the layer A components).

In one embodiment, layer (A) further comprises a vegetable oil (such as sunflower oil, palm oil, rapeseed oil, coconut oil, linseed oil, castor oil, peanut oil, tung oil or soybean oil) or a derivative thereof (such as epoxidized linseed oil, epoxidized tung oil, epoxidized castor oil, acetylated castor oil, epoxidized soybean oil, an epoxidized soybean oil fatty ester or methyl epoxy soyate).

Suitably, layer (A) does not contain any added water as plasticizer (or in any other capacity), due to the hydrophobic nature of the layer. Thus, in one embodiment, layer (A) does not contain water, or contains essentially no water.

Suitable fillers include microcrystalline cellulose, nanocrystalline cellulose and a mineral clay such as Montmorillonite clay.

Suitable surfactants include polysorbate 20, polysorbate 40, polysorbate 80, sorbitan monopalmitate, sorbitan monolaurate, sorbitan monooleate, Triton X-100, monolaurin, monostearin, diacylglycerol and combinations thereof.

Suitable antioxidants include phenolic compounds such as butylated hydroxytoluene (BHT) and butylated hydroxyanisole (BHA), alpha-tocopherol, alpha-tocopherol acetate, 1,3,5-tris(3,5-di-tert-butyl-4-hydroxybenzyl)-1,3,5-triazine-2,4,6(1H,3H,5H)-trione, octadecyl 3-(3,5-di-tert-butyl-4-hydroxyphenyl)propionate, tetrakis(2,4-di-tert-butylphenyl) 4,4′-biphenyldiphosphonite, tris(2,4-ditert-butylphenyl)phosphite and bis-(2,4-di-tert.-butylphenol)pentaerythritol diphosphite.

In one embodiment, layer (A) comprises a polysaccharide (first polysaccharide) selected from the group consisting of cellulose, starch and agar, wherein the polysaccharide (first polysaccharide) has been derivatised to comprise palmitic ester and/or stearic ester moieties. Suitably, layer (A) further comprises a plasticizer which is a vegetable oil or a derivative thereof. Suitably, layer (A) does not contain water.

Layer (A) in standalone form (e.g. in film form) can be prepared using a process such as extrusion (including sheet extrusion and film extrusion), extrusion film blowing, hot pressing or solvent casting (e.g. solution/dispersion casting).

Extrusion is suitably sheet/film extrusion which can be carried out using a sheet extruder or a blown film extruder. General Method B-1 describes an exemplary method for forming layer (A) by extrusion. A suitable process for preparing layer (A) by hot pressing is described in General Method B-2, and in Examples 2a and 2b. A suitable process for preparing layer (A) by solvent casting (e.g. solution/dispersion casting) is described in General Methods Y-2, and C-1. Preferably layer (A) in standalone form (e.g. in film form) is prepared by hot pressing or by solvent casting (e.g. solution/dispersion casting), in particular by hot pressing.

Solvent casting, in the context of the present invention, is the process of producing a film or a coating from a mixture of the material(s) in a solvent, where such mixture can be a solution, a dispersion, a suspension, an emulsion, a colloid. Examples of solvent casting include solution casting, dispersion casting, suspension casting, emulsion casting, colloid casting. The mixture (e.g. solution/dispersion) can be applied by any suitable means including by doctor blade coating, bar coating, spiral wire bar coating, brush coating, spray coating, dip coating, curtain coating, spin coating or by roll coating, and subsequent evaporation of the solvent.

Suitable solvents for preparing layer (A) by solvent casting (e.g. solution/dispersion casting) include esters (ethyl acetate, ethyl propanoate, ethyl butylate, propyl propanoate, butyl butylate, isobutyl butylate, 2-ethoxyethylacetate), ketones (acetone, 2-butanone, 2-pentanone, 3-pentanone, 4-methyl-2-pentanone, 4-heptanone), ethers (tetrahydrofuran, 2-methyltetrahydrofuran, ethylene glycol dimethyl ether, methyl tert-butyl ether), aromatics (benzene, toluene, xylenes, propylbenzene, p-cymene, pyridine), chlorinated (dichloromethane, chloroform), DMSO, N-methyl morpholine and mixtures thereof. In a preferred embodiment, the solvent is ethyl propanoate, 3-pentanone, toluene, 2-methyl THF, 4-methyl-2-pentanone or a mixture thereof. In one embodiment, layer (A) is formed from a solution/dispersion by evaporation (e.g. as in General Method C-1).

Thus, in one embodiment is provided a process for preparing layer (A), wherein layer (A) comprises a polysaccharide (first polysaccharide) which has been derivatised to comprise fatty acid ester moieties, wherein layer (A) is formed by extrusion, by extrusion film blowing, by hot pressing or by solvent casting. Preferably layer (A) is formed by hot pressing or by solvent casting, in particular is formed by hot pressing. In one embodiment, solvent casting is solution/dispersion casting.

The composite materials of the invention further comprise at least one layer (B), comprising a second polysaccharide which is un-derivatised. Un-derivatised in the context of the present invention means that the polysaccharide has not been derivatised to comprise fatty acid ester moieties. In one embodiment, the second polysaccharide has not been chemically modified.

In one embodiment, the second polysaccharide is selected from the group consisting of agar, alginic acid, an alginate salt (e.g. sodium alginate, calcium alginate or potassium alginate), carrageenan, cellulose (including natural cellulose, microcrystalline cellulose and nanocellulose; and including derivatives thereof, such as methylcellulose, ethylcellulose, ethyl methyl cellulose, carboxymethylcellulose, carboxymethylhydroxypropylcellulose, hydroxyethylcellulose, hydroxypropylcellulose and hydroxypropylhydroxylethylcellulose), starch (including derivatives thereof such as hydroxymethyl starch and hydroxypropyl starch) and xanthan gum. Carrageenan includes kappa, Iota and lambda forms, although suitably kappa or iota form is used. Suitably the second polysaccharide is selected from the group consisting of alginic acid, an alginate salt (e.g. sodium alginate, calcium alginate or potassium alginate), carrageenan, cellulose and starch, and in particular is alginic acid or an alginate salt (such as sodium alginate). The base polysaccharide in layer (A) and layer (B) can be the same, but in layer (A) the polysaccharide has been derivatised to comprise fatty acid ester moieties, whereas in layer (B) the polysaccharide is un-derivatised.

Layer (B) may also contain one or more additives in order to modify the structural or functional properties of the layer. In one embodiment, layer (B) comprises an additive selected from the group consisting of a plasticiser, a filler, a surfactant and an antioxidant, or a mixture thereof.

Suitable plasticisers include water, glycerol, sorbitol, mannitol, citric acid, polyethylene glycol, 1,4-butanediol, 1-butanol, tributyl citrate, diethyl adipate, dibutyl sebacate, acetyl tributyl citrate, triethyl citrate, glycerol triacetate, bis(2-ethylhexyl)adipate, glycerol diacetate, poly(ethylene glycol) monolaurate, xylitol, sucrose, glucose and fructose, or any combination thereof. Preferred plasticisers include water and glycerol. In one embodiment, the plasticiser comprises water and one or more compounds selected from the group consisting of glycerol, sorbitol, mannitol, citric acid, polyethylene glycol, 1,4-butanediol and 1-butanol. Suitably, when present, the plasticiser is present in an amount between about 1 wt. % and about 200 wt. %, such as between about 1 wt. % and about 100 wt. %, or between about 1 wt. % and about 40 wt. % (wherein the wt. % refers to the weight relative to the total weight of the layer B components). In one embodiment, layer (B) further comprises water and/or glycerol.

Suitable fillers include microcrystalline cellulose, nanocrystalline cellulose and a mineral clay such as Montmorillonite clay.

Suitable surfactants include polysorbate 20, polysorbate 40, polysorbate 80, sorbitan monopalmitate, sorbitan monolaurate, sorbitan monooleate, Triton X-100, monolaurin, monostearin, diacylglycerol, and combinations thereof.

Suitable antioxidants include phenolic compounds such as butylated hydroxytoluene (BHT) and butylated hydroxyanisole (BHA), alpha-tocopherol, alpha-tocopherol acetate, 1,3,5-tris(3,5-di-tert-butyl-4-hydroxybenzyl)-1,3,5-triazine-2,4,6(1H,3H,5H)-trione, octadecyl 3-(3,5-di-tert-butyl-4-hydroxyphenyl)propionate, tetrakis(2,4-di-tert-butylphenyl) 4,4′-biphenyldiphosphonite, tris(2,4-ditert-butylphenyl)phosphite and bis-(2,4-di-tert.-butylphenol)pentaerythritol diphosphite.

In one embodiment, layer (B) comprises a second polysaccharide selected from the group consisting of alginic acid, an alginate salt, carrageenan, cellulose and starch. Suitably, layer (B) further comprises a plasticizer which is water and/or glycerol.

Layer (B) in standalone form (e.g. in film form) can be prepared using a process such as extrusion (including sheet extrusion and film extrusion), extrusion film blowing, hot pressing or solvent casting (e.g. solution/dispersion casting). Extrusion is suitably sheet/film extrusion which can be carried out using a sheet extruder or a blown film extruder. Preferably layer (B) in standalone form (e.g. in film form) is prepared using solvent casting (e.g. solution/dispersion casting). Suitable processes for preparing layer (B) by solvent casting (e.g. solution/dispersion casting) are described in General Methods Y-1, C-1 and C-2, and in Examples 3a, 3b, 3c and 3d. Suitable solvents for solvent casting (e.g. solution/dispersion casting) layer (B) include water, N-methyl morpholine, DMSO, esters (ethyl acetate, ethyl propanoate, ethyl butylate, propyl propanoate, butyl butylate, isobutyl butylate, 2-ethoxyethylacetate), ketones (acetone, 2-butanone, 2-pentanone, 3-pentanone, 4-methyl-2-pentanone, 4-heptanone), ethers (tetrahydrofuran, 2-methyltetrahydrofuran, ethylene glycol dimethyl ether, methyl tert-butyl ether), chlorinated (dichloromethane, chloroform), and mixtures thereof. In a preferred embodiment, the solvent is water. In one embodiment, layer (B) is formed from a solution/dispersion by evaporation (e.g. as in General Method C-1).

It should be noted that the designation of “first” and “second” polysaccharide for layers (A) and (B), respectively, is intended to indicate that the polysaccharides are part of two separate layers in the composite material (i.e. although the base polysaccharide in layers (A) and (B) can be the same, in layer (A) the polysaccharide has been modified to comprise fatty acid ester moieties, while the polysaccharide in layer (B) is un-derivatised). In embodiments where this is clear, and for aspects of the invention relating to the individual layers, the “first” and “second” designations can be removed without changing the scope of the embodiment.

Layers (A) and (B) combine to form the composite material of the invention.

In one embodiment, layer (A) comprises a first polysaccharide selected from the group consisting of cellulose, starch and agar, wherein the first polysaccharide which has been derivatised to comprise palmitic ester and/or stearic ester moieties; and layer (B) comprises a second polysaccharide selected from the group consisting of alginic acid, an alginate salt, carrageenan, cellulose and starch; wherein

layer (A) optionally further comprises a plasticizer which is a vegetable oil or a vegetable oil derivative, in particular a vegetable oil;

optionally layer (A) does not contain water; and wherein

layer (B) optionally further comprises a plasticizer which is water and/or glycerol.

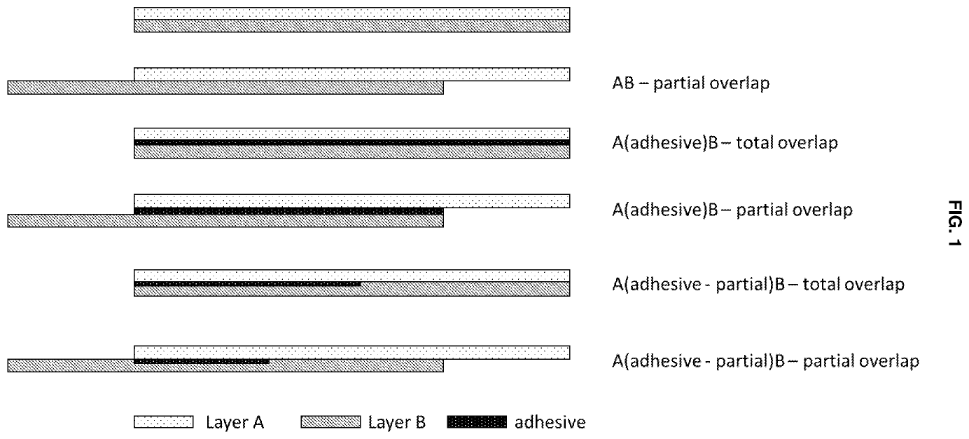

In one embodiment, the composite material is formed by layering layer (A) directly on top of layer (B) (or vice versa), such as shown in FIG. 1: AB. Although in arrangement AB the layers are in direct contact along an entire surface, embodiments are also envisaged in which only a portion of the layers are in direct contact, as shown in FIG. 1: AB—partial overlap.

Thus, in one embodiment, at least a portion of a surface of layer (A) is in contact with at least a portion of a surface of a layer (B). Suitably, substantially all or all of a surface of layer (A) is in contact with substantially all or all of a surface of layer (B).

In the context of the present invention “substantially all” means the majority of a surface e.g. 95% surface coverage, 96% surface coverage, 97% surface coverage, 98% surface coverage or 99% surface coverage.

In one embodiment, the composite material is formed by layering layer (A) on top of layer (B), wherein a layer of adhesive is interposed between the layers, as shown in FIG. 1 (A(adhesive)B). Again, the layers can totally overlap (A(adhesive)B—total overlap) or partially overlap (A(adhesive)B—partial overlap). Thus, in one embodiment, at least a portion of a surface of layer (A) is bonded to at least a portion of a surface of layer (B) using an adhesive.

Suitably, substantially all or all of a surface of layer (A) is bonded to substantially all or all of a surface of layer (B) using an adhesive. Detailed processes for forming the composite material are described below and in the Examples.

In further embodiment, the composite material is formed by a mixture of direct contact between layer (A) and layer (B), and a layer of adhesive interposed between at least a portion of layer (A) and layer (B), see for example FIG. 1 (A(adhesive—partial)B—total overlap) and (A(adhesive—partial)B—partial overlap).

Suitable adhesives include a starch, a starch derivative, a starch ester, casein, protein, cellulose, natural rubber, a polyamide, a polylactide, an acrylate, a styrene-acrylate, a cyanoacrylate, an epoxy resin, a phenol, a polyurethane, a polyvinyl acetate, a polyvinyl alcohol, vinyl acetate ethylene, a urea-formaldehyde and a styrene-butadiene dispersion.

The composite material of the invention comprises at least one layer (A) and least one layer (B) i.e. the minimum number of layers is a single layer of (A) and a single layer of (B).

In one embodiment is provided a composite material comprising or consisting of: a single layer (A) comprising: a first polysaccharide which has been derivatised to comprise fatty acid ester moieties; and, a single layer (B) comprising: a second polysaccharide which is un-derivatised. Layer (A) and layer (B) can be directly in contact with one another (i.e. layer (A) is layered directly on top of layer (B), or vice versa) such that the two layers are in complete contact along an entire surface, or part of a surface. Thus, in one embodiment, at least a portion of a surface of layer (A) is in contact with at least a portion of a surface of layer (B), and preferably substantially all or all of a surface of layer (A) is shown in contact with at substantially all or all of a surface of layer (B), as shown in FIG. 1: AB—total overlap. In another embodiment, layers (A) and (B) are bonded together using an adhesive, placed between the layers. Thus, in one embodiment is provided a composite material comprising or consisting of: a single layer (A) comprising: a first polysaccharide which has been derivatised to comprise fatty acid ester moieties; a single layer (B) comprising: a second polysaccharide which is un-derivatised; and a layer of adhesive positioned between layer (A) and layer (B). In one embodiment, at least a portion of a surface of layer (A) is bonded to at least a portion of a surface of layer (B) by the adhesive. Preferably, substantially all or all of a surface of layer (A) is bonded to substantially all or all of a surface of layer (B) by the adhesive, as shown in FIG. 1: A(adhesive)B—total overlap. In all of the embodiments above, layers (A) and (B) optionally comprise one or more additives as described hereinabove.

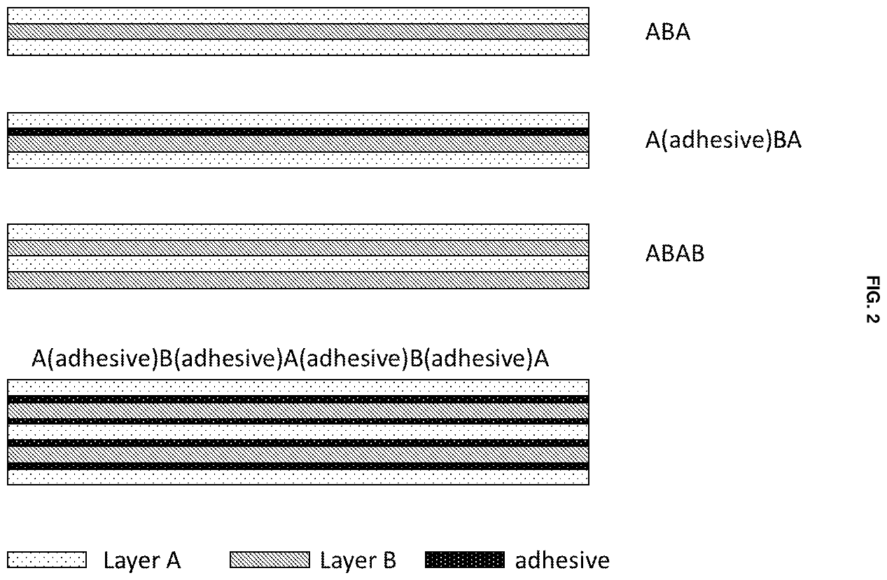

Multilayer composite materials are also provided, such as containing three layers in the arrangement ABA or BAB; containing four layers in the arrangement ABAB (which is considered to be the same as BABA); containing five layers in the arrangement ABABA or BABAB; containing six layers in the arrangement ABABAB (which is considered to be the same as BABABA); containing seven layers in the arrangement ABABABA or BABABAB; or containing eight layers in the arrangement ABABABAB (which is considered to be the same as BABABABA). In all of the above arrangements the layers can be completely overlapping or can partially overlap, and the layers can be directly bonded together or can be bonded together using an adhesive. Mixed arrangements of total overlap/partial overlap/direct bonding/adhesive within a single material are also contemplated. FIG. 2 shows an arrangement ABA (direct bonding with no adhesive, and the layers ABA completely overlap); the arrangement ABA but with a single layer of adhesive between one layer of (A) and layer (B) (labelled as “A(adhesive)BA”); a four layer arrangement ABAB (with no adhesive layers); and a five layer arrangement ABABA, with four layers of adhesive between each AB/BA pair of layers. Although not illustrated, as mentioned above, embodiments where layers are partially overlapping, and embodiments where layers are bonded using a mixture of direct contact and adhesive are also contemplated.

Thus, in one embodiment is provided a composite material as described herein, comprising or consisting of three layers in the arrangement ABA, optionally comprising a layer of adhesive between one or more of the layers.

In one embodiment is provided a composite material as described herein, comprising or consisting of three layers in the arrangement BAB, optionally comprising a layer of adhesive between one or more of the layers.

In one embodiment is provided a composite material as described herein, comprising or consisting of four layers in the arrangement ABAB, optionally comprising a layer of adhesive between one or more of the layers.

In one embodiment is provided a composite material as described herein, comprising or consisting of five layers in the arrangement ABABA, optionally comprising a layer of adhesive between one or more of the layers.

In one embodiment is provided a composite material as described herein, comprising or consisting of five layers in the arrangement BABAB, optionally comprising a layer of adhesive between one or more of the layers.

In one embodiment is provided a composite material as described herein, comprising or consisting of six layers in the arrangement ABABAB, optionally comprising a layer of adhesive between one or more of the layers.

In one embodiment is provided a composite material comprising or consisting of: a single layer (A) comprising: a first polysaccharide which has been derivatised to comprise fatty acid ester moieties; and, a single layer (B) comprising: a second polysaccharide which is un-derivatised; wherein the first polysaccharide selected from the group consisting of cellulose, starch and agar, wherein the first polysaccharide has suitably been derivatised to comprise palmitic ester and/or stearic ester moieties;

layer (B) comprises a second polysaccharide selected from the group consisting of alginic acid, an alginate salt, carrageenan, cellulose and starch; and

optionally comprising a layer of adhesive between layer (A) and layer (B).

Suitably, layer (A) further comprises a plasticizer which is a vegetable oil or a derivative thereof, and layer (B) comprises a plasticiser which is water and/or glycerol.

In one embodiment is provided a composite material comprising or consisting of three layers in the arrangement ABA, optionally comprising a layer of adhesive between one or more of the layers, wherein

layer (A) comprises: a first polysaccharide which has been derivatised to comprise fatty acid ester moieties; and, a single layer (B) comprising: a second polysaccharide which is un-derivatised; wherein

the first polysaccharide selected from the group consisting of cellulose, starch and agar, wherein the first polysaccharide has suitably been derivatised to comprise palmitic ester and/or stearic ester moieties; and

layer (B) comprises a second polysaccharide selected from the group consisting of alginic acid, an alginate salt, carrageenan, cellulose and starch.

Suitably, layer (A) further comprises a plasticizer which is a vegetable oil or a derivative thereof, and suitably layer (B) comprises a plasticiser which is water and/or glycerol.

In one embodiment is provided a composite material comprising or consisting of three layers in the arrangement BAB, optionally comprising a layer of adhesive between one or more of the layers; wherein

layer (A) comprises: a first polysaccharide which has been derivatised to comprise fatty acid ester moieties; and, a single layer (B) comprising: a second polysaccharide which is un-derivatised; wherein

the first polysaccharide selected from the group consisting of cellulose, starch and agar, wherein the first polysaccharide has suitably been derivatised to comprise palmitic ester and/or stearic ester moieties; and

layer (B) comprises a second polysaccharide selected from the group consisting of alginic acid, an alginate salt, carrageenan, cellulose and starch.

Suitably, layer (A) further comprises a plasticizer which is a vegetable oil or a derivative thereof, and suitably layer (B) comprises a plasticiser which is water and/or glycerol.

In one embodiment is provided a composite material comprising or consisting of four layers in the arrangement ABAB, optionally comprising a layer of adhesive between one or more of the layers; wherein

layer (A) comprises: a first polysaccharide which has been derivatised to comprise fatty acid ester moieties; and, a single layer (B) comprising: a second polysaccharide which is un-derivatised; wherein

the first polysaccharide selected from the group consisting of cellulose, starch and agar, wherein the first polysaccharide has suitably been derivatised to comprise palmitic ester and/or stearic ester moieties; and

layer (B) comprises a second polysaccharide selected from the group consisting of alginic acid, an alginate salt, carrageenan, cellulose and starch.

Suitably, layer (A) further comprises a plasticizer which is a vegetable oil or a derivative thereof, and suitably layer (B) comprises a plasticiser which is water and/or glycerol.

In one embodiment is provided a composite material comprising or consisting of five layers in the arrangement ABABA, optionally comprising a layer of adhesive between one or more of the layers; wherein

layer (A) comprises: a first polysaccharide which has been derivatised to comprise fatty acid ester moieties; and, a single layer (B) comprising: a second polysaccharide which is un-derivatised; wherein

the first polysaccharide selected from the group consisting of cellulose, starch and agar, wherein the first polysaccharide has suitably been derivatised to comprise palmitic ester and/or stearic ester moieties; and layer (B) comprises a second polysaccharide selected from the group consisting of alginic acid, an alginate salt, carrageenan, cellulose and starch.

Suitably, layer (A) further comprises a plasticizer which is a vegetable oil or a derivative thereof, and suitably layer (B) comprises a plasticiser which is water and/or glycerol.

In one embodiment is provided a composite material comprising or consisting of five layers in the arrangement BABAB, optionally comprising a layer of adhesive between one or more of the layers; wherein

layer (A) comprises: a first polysaccharide which has been derivatised to comprise fatty acid ester moieties; and, a single layer (B) comprising: a second polysaccharide which is un-derivatised; wherein

the first polysaccharide selected from the group consisting of cellulose, starch and agar, wherein the first polysaccharide has suitably been derivatised to comprise palmitic ester and/or stearic ester moieties; and

layer (B) comprises a second polysaccharide selected from the group consisting of alginic acid, an alginate salt, carrageenan, cellulose and starch.

Suitably, layer (A) further comprises a plasticizer which is a vegetable oil or a derivative thereof, and suitably layer (B) comprises a plasticiser which is water and/or glycerol.

In one embodiment is provided a composite material comprising or consisting of six layers in the arrangement ABABAB, optionally comprising a layer of adhesive between one or more of the layers; wherein

layer (A) comprises: a first polysaccharide which has been derivatised to comprise fatty acid ester moieties; and, a single layer (B) comprising: a second polysaccharide which is un-derivatised; wherein

the first polysaccharide selected from the group consisting of cellulose, starch and agar, wherein the first polysaccharide has suitably been derivatised to comprise palmitic ester and/or stearic ester moieties; and

layer (B) comprises a second polysaccharide selected from the group consisting of alginic acid, an alginate salt, carrageenan, cellulose and starch.

Suitably, layer (A) further comprises a plasticizer which is a vegetable oil or a derivative thereof, and suitably layer (B) comprises a plasticiser which is water and/or glycerol.

The materials and composite materials of the invention have excellent water barrier properties and in certain cases excellent oxygen barrier properties, while still being biodegradable, as demonstrated in Examples 10-14. As such, materials and composite materials of the invention have particular utility in packaging applications, in particular packaging for food, beverages, food supplements, vitamins, personal hygiene products, cosmetic products, products containing active agents and cleaning products.

The materials of the invention have utility in their own right, for example when in the form of a film, e.g. a packaging film. The materials of the invention can also be applied to a surface of a substrate, which provides additional mechanical support for the material, allowing it to be used in packaging applications which require a more rigid material. In one embodiment, the substrate is or comprises a packaging material.

In one embodiment is provided the use of a material or composite material as described herein as a packaging material. In one embodiment is provided the use of a material or a composite material as described herein as a coating for a substrate. Suitably, the substrate is or comprises a packaging material.

The substrate typically comprises, or is based on a carbohydrate material e.g. cellulose. Suitable substrates include paper, cardboard, corrugated board, paperboard, carton board, fibre and fabric, or a mixture thereof. “Fibre” as used herein includes wet moulded fibre and dry moulded fibre. The substrate itself may already be used as a packaging material, but when combined with the materials of the invention is enhanced by having greater water barrier properties and/or greater oxygen barrier properties.

In one embodiment, a surface of a substrate has a coating comprising the material or composite material as described herein. Part of a single surface of the substrate can be coated, or an entire surface can be coated. If the substrate is a material in a form with two major surfaces (e.g. in 2D sheet form, or in 3D form such as in the form of a container with an inner and an outer surface (e.g. a tray, bowl, cup, sachet, pouch, tube or bottle)), then one or both of the (major) surfaces can be coated, and each surface can be partially coated or fully coated.

Thus, in one aspect of the invention is provided a substrate with a surface having a coating comprising a material of the invention as described herein. Substrates with coatings comprising materials of the invention are of use in various packaging applications, including for food and beverages, food supplements, vitamins, personal hygiene and cosmetic products, products containing active agents e.g. therapeutic agents, and cleaning products such as detergents.

Food includes solid items and semi-solid items such as viscous solutions and suspensions. Beverages include alcoholic beverages. Food and beverages can be hot or cold. All possible items that are intended for consumption may be consumed by humans, but items intended for consumption by animals are also covered e.g. pet food. Personal hygiene and cosmetic products include shampoo, conditioner, shower gel, body wash, soap, liquid soap, hair gel, hair cream, cleanser, toner, serum, moisturiser, face masks, balms, exfoliants, toothpaste, mouthwash, makeup, and suncream.

In one embodiment is provided a substrate with a surface having a coating comprising a material as described herein, wherein the substrate is or comprises a packaging material.

In one embodiment is provided a packaging material with a surface having a coating comprising a material as described herein. In another embodiment is provided a packaging container comprising a surface having a coating comprising a material or composite material as described herein. In one embodiment, the packaging container contains a food, a beverage, a food supplement, a vitamin, a personal hygiene product, a cosmetic product, a product containing an active agent or a cleaning product. Reference herein to “a” is intended to encompass more than one.

In one embodiment, the substrate is in sheet form. In another embodiment, the substrate is in the form of a container with an inner and outer surface (e.g. a tray, bowl, cup, sachet, pouch, tube or bottle).

Thus, in one aspect of the invention is provided a substrate with a surface having a coating comprising a material, wherein the material comprises:
a layer (A) comprising a polysaccharide which has been derivatised to comprise fatty acid ester moieties.

Suitably, layer (A) is a single layer. Embodiments and preferences described above in relation to the layer (A) and the substrate apply equally to this aspect of the invention.

In a further aspect of the invention is provided a substrate with a surface having a coating comprising a material, wherein the material comprises:
a layer (B) comprising an un-derivatised polysaccharide.

Suitably, layer (B) is a single layer. Embodiments and preferences described above in relation to the layer (B) and the substrate apply equally to this aspect of the invention.

In a further aspect of the invention is provided a substrate with a surface having a coating comprising a composite material, wherein the composite material comprises:
at least one layer (A) comprising a first polysaccharide which has been derivatised to comprise fatty acid ester moieties; and
at least one layer (B) comprising a second polysaccharide which is un-derivatised.

Embodiments and preferences described above in relation to the composite material of the invention apply equally to the coated substrate aspect of the invention.

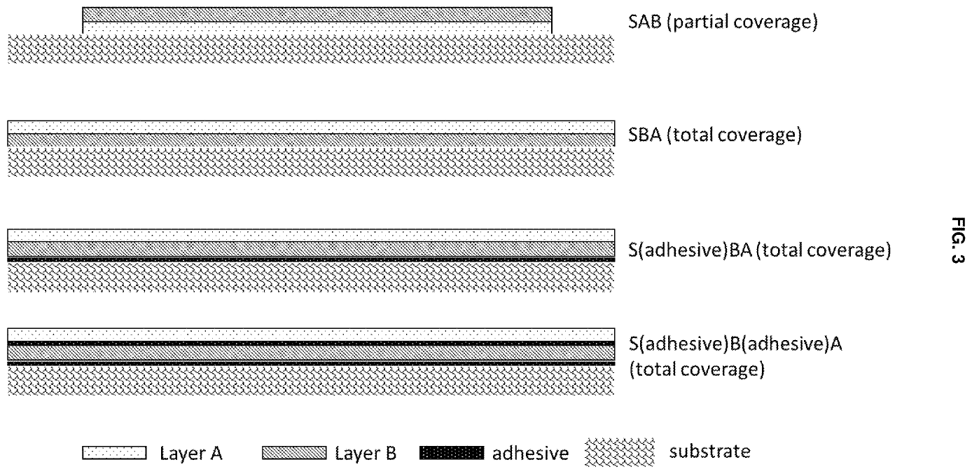

As the composite material of the invention contains two different layers (A) and (B), either one of layer (A) or layer (B) can be in closest proximity to the surface of the substrate being coated. For example, where the composite material contains two layers (a single layer (A) and a single layer (B)), there are two alternative arrangements: the first in which layer (A) is closest to the substrate (designated “S”): SAB (as shown in FIG. 3); and the second in which layer (B) is closest to the substrate: SBA (as shown in FIG. 3).

The material and composite material can be directly applied to a surface of the substrate or can be attached to a surface of the substrate using a layer of adhesive. Suitable adhesives include a starch, a starch derivative, a starch ester, casein, protein, cellulose, natural rubber, a polyamide, a polylactide, an acrylate, a styrene-acrylate, a cyanoacrylate, an epoxy resin, a phenol, a polyurethane, a polyvinyl acetate, a polyvinyl alcohol, vinyl acetate ethylene, a urea-formaldehyde and a styrene-butadiene dispersion. In embodiments where the composite material also contains an adhesive layer (an example is shown in FIG. 3: S(adhesive)B(adhesive)A), the adhesives used can be the same or different.

In one embodiment is provided a substrate (S) with a surface having a coating comprising a material as described herein, wherein the material comprises or consists of a layer (A) comprising a polysaccharide which has been derivatised to comprise fatty acid ester moieties, and optionally a layer of adhesive between layer (A) and the surface of the substrate. Suitably layer (A) is a single layer.

In one embodiment is provided a substrate (S) with a surface having a coating comprising a material as described herein, wherein the material comprises or consists of a layer (B) comprising an un-derivatised polysaccharide, optionally comprising a layer of adhesive between layer (B) and the surface of the substrate.

In one embodiment is provided a substrate (S) with a surface having a coating comprising a composite material as described herein, wherein the composite material comprises or consists of two layers in the arrangement SAB, optionally comprising a layer of adhesive between one or more of the layers. Specific examples include: S(adhesive)AB, S(adhesive)A(adhesive)B and SA(adhesive)B.

In one embodiment is provided a substrate (S) with a surface having a coating comprising a composite material as described herein, wherein the composite material comprises or consists of two layers in the arrangement SBA, optionally comprising a layer of adhesive between one or more of the layers. Specific examples include: S(adhesive)BA, S(adhesive)B(adhesive)A and SB(adhesive)A.

In one embodiment is provided a substrate (S) with a surface having a coating comprising a composite material as described herein, wherein the composite material comprises or consists of three layers in the arrangement SBAB, optionally comprising a layer of adhesive between one or more of the layers. Specific examples include: S(adhesive)BAB, S(adhesive)B(adhesive)AB, S(adhesive)B(adhesive)A(adhesive)B, S(adhesive)BA(adhesive)B, SB(adhesive)A(adhesive)B, SBA(adhesive)B and SB(adhesive)AB.

In one embodiment is provided a substrate (S) with a surface having a coating comprising a composite material as described herein, wherein the composite material comprises or consists of three layers in the arrangement SABA, optionally comprising a layer of adhesive between one or more of the layers. Specific examples include: S(adhesive)ABA, S(adhesive)A(adhesive)BA, S(adhesive)A(adhesive)B(adhesive)A, S(adhesive)AB(adhesive)A, SA(adhesive)B(adhesive)A, SAB(adhesive)A and SA(adhesive)BA.

In one embodiment is provided a substrate (S) with a surface having a coating comprising a composite material as described herein, wherein the composite material comprises or consists of four layers in the arrangement SBABA, optionally comprising a layer of adhesive between one or more of the layers. Specific examples include: S(adhesive)BABA, S(adhesive)B(adhesive)ABA, S(adhesive)B(adhesive)A(adhesive)BA, S(adhesive)B(adhesive)A(adhesive)B(adhesive)A, S(adhesive)BA(adhesive)BA, S(adhesive)BA(adhesive)B(adhesive)A, S(adhesive)B(adhesive)ABA, S(adhesive)B(adhesive)AB(adhesive)A, S(adhesive)B(adhesive)A(adhesive)BA, S(adhesive)BABA, S(adhesive)B(adhesive)ABA, S(adhesive)B(adhesive)A(adhesive)BA, SB(adhesive)A(adhesive)B(adhesive)A, SBA(adhesive)BA, SBA(adhesive)B(adhesive)A, SB(adhesive)ABA, SB(adhesive)AB(adhesive)A and SB(adhesive)A(adhesive)BA.

In one embodiment is provided a substrate (S) with a surface having a coating comprising a composite material as described herein, wherein the composite material comprises or consists of four layers in the arrangement SABAB, optionally comprising a layer of adhesive between one or more of the layers. Specific examples include: S(adhesive)ABAB, S(adhesive)A(adhesive)BAB, S(adhesive)A(adhesive)B(adhesive)AB, S(adhesive)A(adhesive)B(adhesive)A(adhesive)B, S(adhesive)AB(adhesive)AB, S(adhesive)AB(adhesive)A(adhesive)B, S(adhesive)A(adhesive)BAB, S(adhesive)A(adhesive)BA(adhesive)B, S(adhesive)A(adhesive)B(adhesive)AB, S(adhesive)ABAB, S(adhesive)A(adhesive)BAB, S(adhesive)A(adhesive)B(adhesive)AB, SA(adhesive)B(adhesive)A(adhesive)B, SAB(adhesive)AB, SAB(adhesive)A(adhesive)B, SA(adhesive)BAB, SA(adhesive)BA(adhesive)B and SA(adhesive)B(adhesive)AB.

When the substrate is a material in a form with two major surfaces (e.g. in sheet form, or in container form with an inside and an outside surface) the coating comprising a material of the invention can be applied to both surfaces (including a portion of both surfaces, a portion of one surface and substantially all or all of the other surface, or preferably substantially all or all of both surfaces). The material applied to one surface can be different to the material applied to the other surface, but suitably the materials are the same, particularly in the context of the composite material. Suitably, the composite materials are applied in the same arrangement on each surface i.e. the same type of layer (either layer A or layer B) is in closest proximity to the each surface being coated.

Thus, in one embodiment is provided a substrate (S) with a first surface having a coating comprising a composite material as described herein and a second surface having a coating comprising a composite material as described herein, wherein the composite material comprises or consists of layers in the arrangement BASAB, optionally comprising a layer of adhesive between one or more of the layers. Specific examples include: BAS(adhesive)AB, BAS(adhesive)A(adhesive)B, BASA(adhesive)B, B(adhesive)AS(adhesive)AB, B(adhesive)AS(adhesive)A(adhesive)B, B(adhesive)ASA(adhesive)B, BA(adhesive)S(adhesive)AB, BA(adhesive)S(adhesive)A(adhesive)B, BA(adhesive)SA(adhesive)B, B(adhesive)A(adhesive)S(adhesive)AB, B(adhesive)A(adhesive)S(adhesive)A(adhesive)B and B(adhesive)A(adhesive)SA(adhesive)B.

In another embodiment is provided a substrate (S) with a first surface having a coating comprising a composite material as described herein and a second surface having a coating comprising a composite material as described herein, wherein the composite material comprises or consists of layers in the arrangement ABSBA, optionally comprising a layer of adhesive between one or more of the layers. Specific examples include: ABS(adhesive)BA, ABS(adhesive)B(adhesive)A, ABSB(adhesive)A, A(adhesive)BS(adhesive)BA, A(adhesive)BS(adhesive)B(adhesive)A, A(adhesive)BSB(adhesive)A, AB(adhesive)S(adhesive)BA, AB(adhesive)S(adhesive)B(adhesive)A, AB(adhesive)SB(adhesive)A, A(adhesive)B(adhesive)S(adhesive)BA, A(adhesive)B(adhesive)S(adhesive)B(adhesive)A and A(adhesive)B(adhesive)SB(adhesive)A.

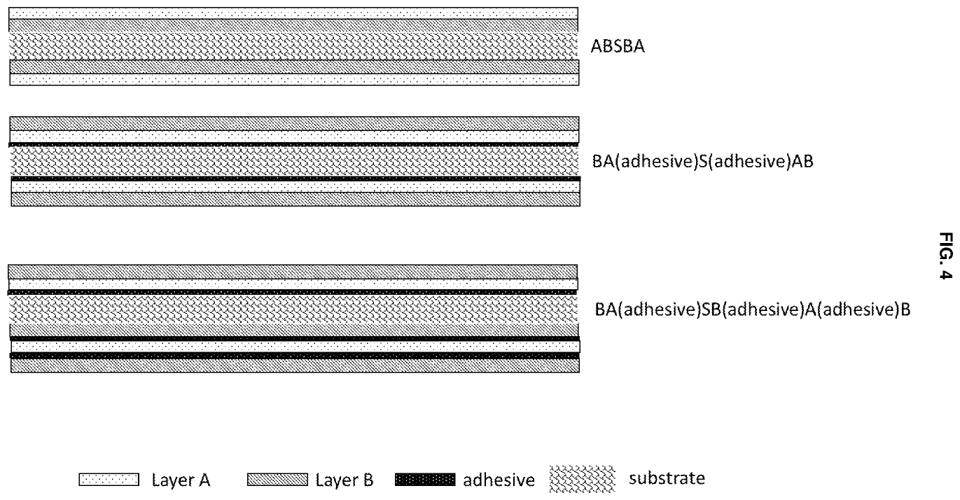

FIG. 4 shows the arrangement ABSBA, where the same composite material is used to coat both surfaces, and the composite material is applied to each surface in the same orientation (i.e. the layer (B) surface is applied to each surface, and in the embodiment illustrated the material is applied directly to the surface with no adhesive. An arrangement BA(adhesive)S(adhesive)AB is also shown, where the composite material itself (AB/BA) does not contain any adhesive, but the material is bonded to both surfaces of the substate by an adhesive layer. The third arrangement illustrated in FIG. 4 shows a substrate where one surface is coated with a first composite material, and the other surface is coated with a second (in this case different) composite material. The first surface is coated with composite material BA, where the composite material does not contain any adhesive, but the material is bonded via layer (A) to the first surface using a layer of adhesive. The second surface is coated with composite material BAB, where the material contains a layer of adhesive between each of the layers. The composite material is bonded directly to the second surface via layer (B), without using a layer of adhesive.

In another embodiment is provided a substrate (S) with a first surface having a coating comprising a material as described herein and a second surface having a coating comprising a material as described herein, wherein the material comprises:
a layer (A) comprising a polysaccharide which has been derivatised to comprise fatty acid ester moieties;

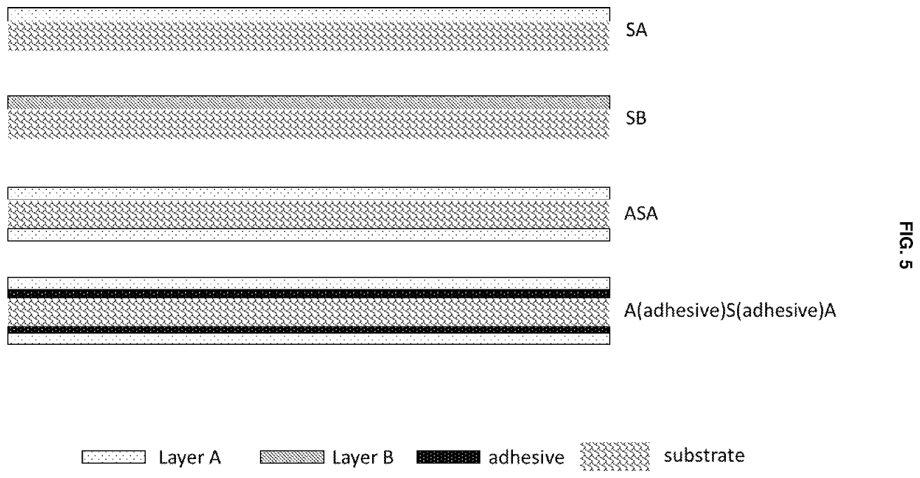

optionally comprising a layer of adhesive between one or more of the layers. Specific examples include: ASA, A(adhesive)SA, AS(adhesive)A and A(adhesive)S(adhesive)A, as shown in FIG. 5.

As described above, also contemplated are substrates as described herein with a single layer (A) or (B) (i.e. not a composite layer).

Also contemplated is a substrate (S) with a first surface having a coating comprising a single layer (A) comprising a polysaccharide which has been derivatised to comprise fatty acid ester moieties; and a second surface having a coating comprising a single layer (B) comprising an un-derivatised polysaccharide. This arrangement BSA (or ASB), optionally comprises a layer of adhesive between one or more of the layers and the surface of the substrate. Specific examples include: BSA, BS(adhesive)A, B(adhesive)SA, and B(adhesive)S(adhesive)A.

Embodiments and preferences described above in relation to the layers (A) and (B) and the substrate apply equally to this aspect of the invention.

The material can be directly applied to a surface of the substrate or can be attached to a surface of the substrate using a layer of adhesive. Suitable adhesives include a starch, a starch derivative, a starch ester, casein, protein, cellulose, natural rubber, a polyamide, a polylactide, an acrylate, a styrene-acrylate, a cyanoacrylate, an epoxy resin, a phenol, a polyurethane, a polyvinyl acetate, a polyvinyl alcohol, vinyl acetate ethylene, a urea-formaldehyde and a styrene-butadiene dispersion. Where the substrate is in sheet form, the adhesive can be applied to both surfaces (or a portion of both surfaces).

FIG. 5 shows the arrangement SA, in which layer (A) is applied to one surface, and is directly bonded to the surface without using adhesive. The same arrangement for SB is also illustrated. Also shown is the arrangement ASA and A(adhesive)S(adhesive)A, in which both sides of the substrate are coated with layer (A), without the use of adhesive and with the use of adhesive, respectively.

In one embodiment is provided a substrate with a surface having a coating comprising a composite material, wherein the composite material comprises:
at least one layer (A) comprising a first polysaccharide which has been derivatised to comprise fatty acid ester moieties; and
at least one layer (B) comprising a second polysaccharide which is un-derivatised; wherein

layer (A) comprises a first polysaccharide selected from the group consisting of cellulose, starch and agar, wherein the first polysaccharide which has been derivatised to comprise palmitic ester and/or stearic ester moieties; and layer (B) comprises a second polysaccharide selected from the group consisting of alginic acid, an alginate salt, carrageenan, cellulose and starch; wherein,

layer (A) optionally further comprises a plasticizer which is a vegetable oil or a derivative thereof;

optionally layer (A) does not contain water; and wherein layer (B) optionally further comprises a plasticizer which is water and/or glycerol. Suitably, the substrate is selected from the group consisting of paper, cardboard, corrugated board, paperboard, carton board, fibre and fabric, and mixtures thereof.

Both the substrate and the materials of the invention (i.e. layer (A), layer (B) and composite material comprising both layers (A) and (B)) are preferably biodegradable. Thus, in one embodiment, the substrate is biodegradable. In one embodiment, the material of the invention is biodegradable. In one embodiment, the substrate having a coating comprising a material of the invention, is biodegradable. Both the substrate and the materials of the invention are preferably compostable. Thus, in one embodiment, the substrate is compostable. In one embodiment, the material of the invention is compostable. In one embodiment, the substrate having a coating comprising the material of the invention, is compostable.

Biodegradability can be assessed using the “Degradability in soil environment” study in Evaluation Methods and Example 11, and using the “Anaerobic digestion” study in Evaluation Methods and Example 12. Compostability can be assessed by an analogous method using compost instead of soil.

Various processes for preparing the materials, composite materials and coated substrates of the invention will now be described. All embodiments and preferences described above with respect to the material and composite material (layers (A) and (B), adhesives, arrangements etc.) and the substrate (nature of the substrate and coating arrangements etc) apply equally to the following processes.

Suitable processes for preparing individual (standalone) layers (A) and (B) are described hereinabove.

The standalone layers (A) and (B) can be directly bonded to each other to form a composite material e.g. by using heat and/or pressure, or can be bonded using a layer of adhesive. In one embodiment, the layers are directly bonded together by coextrusion or by hot pressing. An exemplary method for forming composite material ABA by hot pressing is described in General Method D-1, and in Example 4.

Suitable adhesives are described hereinabove.

Thus, in one embodiment is provided a process for preparing a composite material (e.g. AB) comprising the steps of:
a) forming a layer (A) comprising: a first polysaccharide which has been derivatised to comprise fatty acid ester moieties;
b) forming a layer (B) comprising: a second polysaccharide which is un-derivatised;
c) applying layer (B) (formed in step b)) to layer (A) (formed in step a)), then applying heat and/or pressure.

Step a) is suitably carried out by extrusion, by extrusion film blowing, by hot pressing or by solvent casting (as described above), in particular by hot pressing or by solvent casting, and preferably by hot pressing. Step b) is suitably carried out by extrusion, by extrusion film blowing, by hot pressing or by solvent casting; in particular by solvent casting. Step c) is suitably carried out by hot pressing. Layers (A) and (B) optionally comprise one or more additives as described hereinabove. In one embodiment, solvent casting is solution/dispersion casting.

In another embodiment is provided a process for preparing a composite material (e.g. BA) comprising the steps of:
a) forming a layer (B) comprising: a second polysaccharide which is un-derivatised;
b) forming a layer (A) comprising: a first polysaccharide which has been derivatised to comprise fatty acid ester moieties;
c) applying layer (A) (formed in step b)) to layer (B) (formed in step a)), then applying heat and/or pressure.

Step a) is suitably carried out by extrusion, by extrusion film blowing, by hot pressing or by solvent casting (as described above), in particular by solvent casting. Step b) is suitably carried out by extrusion, by extrusion film blowing, by hot pressing or by solvent casting; in particular by hot pressing or by solvent casting, and preferably by hot pressing. Step c) is suitably carried out by hot pressing. Layers (A) and (B) optionally comprise one or more additives as described hereinabove. In one embodiment, solvent casting is solution/dispersion casting.

In both of the embodiments above, further layers (A) and (B) can be applied before step c), to form composite materials with multiple layers e.g. ABA, BAB, ABAB etc.

Considering the use of an adhesive to bond together layers (A) and (B), in one embodiment is provided a process for preparing a composite material (e.g. AB) comprising the steps of:
a) forming a layer (A) comprising: a first polysaccharide which has been derivatised to comprise fatty acid ester moieties;
b) applying a layer of adhesive (to the layer formed in step a));
c) forming a layer (B) comprising: a second polysaccharide which is un-derivatised,
d) applying layer (B) (formed in step c)) to the layer of adhesive (formed in step b)).

Step a) is suitably carried out by extrusion, by extrusion film blowing, by hot pressing or by solvent casting; in particular by hot pressing or by solvent casting, and preferably by hot pressing. Step c) is suitably carried out by extrusion, by extrusion film blowing, by hot pressing or by solvent casting, in particular by solvent casting. Layers (A) and (B) optionally comprise one or more additives as described hereinabove. In one embodiment, solvent casting is solution/dispersion casting.

In another embodiment is provided a process for preparing a composite material (e.g. BA) comprising the steps of:
a) forming a layer (B) comprising: a second polysaccharide which is un-derivatised; b) applying a layer of adhesive (to the layer formed in step a));
c) forming a layer (A) comprising: a first polysaccharide which has been derivatised to comprise fatty acid ester moieties,
d) applying layer (A) (formed in step c)) to the layer of adhesive (formed in step b)).

Step a) is suitably carried out by extrusion, by extrusion film blowing, by hot pressing or by solvent casting; in particular by solvent casting. Step c) is suitably carried out by extrusion, by extrusion film blowing, by hot pressing or by solvent casting, in particular by hot pressing or by solvent casting, and preferably by hot pressing. Layers (A) and (B) optionally comprise one or more additives as described hereinabove. In one embodiment, solvent casting is solution/dispersion casting.

Alternatively, a standalone layer of (A) or (B) can be formed as described above, and then a subsequent layer (B or A) can be formed in situ on the preformed layer, for example by solvent casting (e.g. solution/dispersion casting), as described in General Method W and in Example 5. Suitable solvents for solution/dispersion casting include esters (ethyl acetate, ethyl propanoate, ethyl butylate, propyl propanoate, butyl butylate, isobutyl butylate, 2-ethoxyethylacetate), ketones (acetone, 2-butanone, 2-pentanone, 3-pentanone, 4-methyl-2-pentanone, 4-heptanone), ethers (tetrahydrofuran, 2-methyltetrahydrofuran, ethylene glycol dimethyl ether, methyl tert-butyl ether), aromatics (benzene, toluene, xylenes, propylbenzene, p-cymene, pyridine), chlorinated (dichloromethane, chloroform), water (layer B only), and mixtures thereof.

Thus, in one aspect, the present invention provides a process for preparing a composite material (e.g. AB), comprising the steps of:
a) forming a layer (A) comprising: a first polysaccharide which has been derivatised to comprise fatty acid ester moieties; and
b) treating at least a portion of a surface of layer (A) (formed in step a)) to form a layer (B) comprising a second polysaccharide which is un-derivatised.

Step a) is suitably carried out by extrusion, by extrusion film blowing, by hot pressing or by solvent casting; in particular by hot pressing or by solvent casting, and preferably by hot pressing. Step b) is suitably carried out by solvent casting. Layers (A) and (B) optionally comprise one or more additives as described hereinabove. In one embodiment, solvent casting is solution/dispersion casting.

In another aspect, the present invention proves a process for preparing a composite material (e.g. BA), comprising the steps of:
a) forming a layer (B) comprising: a second polysaccharide which is un-derivatised; and
b) treating at least a portion of a surface of layer (B) (formed in step a)) to form a layer (A) comprising a first polysaccharide which has been derivatised to comprise fatty acid ester moieties.

Step a) is suitably carried out by extrusion, by extrusion film blowing, by hot pressing or by solvent casting; in particular by solvent casting. Step b) is suitably carried out by solution/dispersion casting. Layers (A) and (B) optionally comprise one or more additives as described hereinabove. In one embodiment, solvent casting is solution/dispersion casting.

Also provided are processes for preparing composite materials comprising forming third and subsequent layers, such as ABA, BAB, ABAB etc., by repeating the steps for forming AB/BA composite materials already described.

As described above, the composite material of the invention can be applied to the surface of a substrate to form a coating. The composite material can be pre-formed using the processes described directly above and then applied to the substrate. Alternatively, the composite material can formed directly on the surface of the substrate (i.e. the coating is formed and applied to the substrate in situ), e.g. by forming the individual layer(s) directly and sequentially onto the surface of the substrate.

The same applies for materials comprising either of layers (A) or (B): they can be pre-formed using the processes described above and then applied to the substrate. Alternatively, the material can be formed in situ, directly on the surface of the substrate.

Considering the method of applying a pre-formed composite material, in one embodiment is provided a process for preparing a substrate having a coating, wherein the coating comprises a composite material, the process comprising the steps of:
a) preparing a composite material as described herein; and
b) applying the composite material to at least a portion of a surface of the substate using pressure and optionally heat.

Considering the method of applying a single layer (A) or (B) which has been pre-formed, in one embodiment is provided a process for preparing a substrate having a coating, wherein the coating comprises a material, the process comprising the steps of:
a) preparing a material comprising a layer (A) or (B) as described herein; and
b) applying the material to at least a portion of a surface of the substate using pressure and optionally heat.

In one embodiment the layer (A) or (B) is a single layer (A) or (B).

For all embodiments where a material or composite material layer is pre-formed and then applied to a surface of a substrate, the material or composite material can be applied and bonded to the substrate using a process such as hot pressing, coextrusion, flow lamination, hot or cold rolling, or calender rolling. Suitable application pressures for rolling and extrusion processes are from 0 bar(g) to 200 bar(g). Suitable processing temperatures are from 30° C. to 220° C., and suitable equipment includes but is not limited to single-screw extruders, twin-screw extruders, extrusion dies, flow through forming plates and static forms, hydraulic presses (heated or not), screw presses (heated or not), flow lamination lines, single, twin, and multiple roller rolling lines, calender rollers. Preferably step b) is carried out by hot pressing, such as in Example 7b.

Alternatively, the pre-formed material can be bonded to the surface of the substrate using a layer of adhesive. Suitably adhesives are described hereinabove.

Thus, in one embodiment is provided a process for preparing a substrate having a coating, wherein the coating comprises a composite material, the process comprising the steps of:
a) preparing a composite material as described herein;
b) treating at least a portion of a surface of the substrate to form a layer of adhesive;
c) applying the composite material (formed in step a)) to the layer of adhesive (formed in step b).

In one embodiment is provided a process for preparing a substrate having a coating, wherein the coating comprises a material, the process comprising the steps of:
a) preparing a material comprising a single layer (A) or (B) as described herein;
b) treating at least a portion of a surface of the substrate to form a layer of adhesive;
c) applying the material (formed in step a)) to the layer of adhesive (formed in step b).

Considering the method of forming the material in situ when coating the substrate, in one embodiment is provided a process for preparing a substrate having a coating (e.g. SA), wherein the coating comprises a material, the process comprising the steps of:
a′) treating at least a portion of a surface of the substrate to form a layer (A) comprising: a first polysaccharide which has been derivatised to comprise fatty acid ester moieties;

Step a′) is suitably carried out by solvent casting (e.g. solution/dispersion casting). Layer (A) optionally comprises one or more additives as described hereinabove.

Considering the method of forming the material in situ when coating the substrate, in one embodiment is provided a process for preparing a substrate having a coating (e.g. SAB), wherein the coating comprises a composite material, the process comprising the steps of:
a′) treating at least a portion of a surface of the substrate to form a first layer (A) comprising: a first polysaccharide which has been derivatised to comprise fatty acid ester moieties;
b′) treating at least a portion of the surface of layer (A) (formed in step a′) to form a layer (B) comprising: a second polysaccharide which is un-derivatised.

Step a′) is suitably carried out by solvent casting. Step b′) is suitably carried out by solvent casting. Layers (A) and (B) optionally comprise one or more additives as described hereinabove. In one embodiment, solvent casting is solution/dispersion casting.

Also provided is the reverse embodiment, an in situ process for preparing a substrate having a coating (e.g. SBA), wherein the coating comprises a composite material, the process comprising the steps of:
a′) treating at least a portion of a surface of the substrate to form a first layer (B) comprising: a second polysaccharide which is un-derivatised;
b′) treating at least a portion of the surface of layer (B) (formed in step a′) to form a layer (A) comprising: a first polysaccharide which has been derivatised to comprise fatty acid ester moieties.

Step a′) is suitably carried out by solvent casting. Step b′) is suitably carried out by solvent casting. Layers (A) and (B) optionally comprise one or more additives as described hereinabove. An example of this embodiment is described in Example 8. In one embodiment, solvent casting is solution/dispersion casting.

Mixed methods involving at least one layer which is preformed and at least one layer which is formed in situ are also contemplated. Thus, in one embodiment is provided a process for preparing a substrate having a coating (e.g. SAB), wherein the coating comprises a composite material, the process comprising the steps of:
a) forming a layer (A) comprising: a first polysaccharide which has been derivatised to comprise fatty acid ester moieties;
b) applying layer (A) (formed in step a)) to at least a portion of a surface of the substate using pressure and optionally heat;
c) treating at least a portion of the surface of layer (A) (formed in step b)) to form a layer (B) comprising: a second polysaccharide which is un-derivatised.

Step a) is suitably carried out by extrusion, by extrusion film blowing, by hot pressing or by solvent casting; in particular by hot pressing or by solvent casting, and preferably by hot pressing. Step b) is suitably carried out by hot pressing. Step c) is suitably carried out by solvent casting. In one embodiment, solvent casting is solution/dispersion casting.

In one embodiment is provided a process for preparing a substrate having a coating (e.g. SBA), wherein the coating comprises a composite material, the process comprising the steps of:
a) forming a layer (B) comprising: a second polysaccharide which is un-derivatised;
b) applying layer (B) (formed in step a)) to at least a portion of a surface of the substate using pressure and optionally heat;
c) treating at least a portion of the surface of layer (B) (formed in step b)) to form a layer (A) comprising: a first polysaccharide which has been derivatised to comprise fatty acid ester moieties.

Step a) is suitably carried out by extrusion, by extrusion film blowing, by hot pressing or by solvent casting; in particular by solvent casting. Step b) is suitably carried out by hot pressing.

Step c) is suitably carried out by solvent casting. An example of this embodiment is described in Example 9. In one embodiment, solvent casting is solution/dispersion casting.

### Advantages

Materials of the invention and substrates coated with materials of the invention are, at least in some embodiments, expected to have one or more of the following merits or advantages:
good water and water vapour barrier properties e.g. as measured using liquid water permeability, water vapour transmission rate and surface absorption of water, as set out in the Evaluation Methods below (Liquid water permeability (LWP) method, Water vapour transmission rate (WVTR) and Cobb test;
good oxygen barrier properties e.g. as measured using oxygen transmission rate, as set out in the Evaluation Methods below (Oxygen transmission rate (OTR) method);
providing a thin coating e.g. as measured using the layer and material thickness method in the Evaluation Methods below;
enhanced biodegradability e.g. as measured using Degradability in soil environment method and Anaerobic digestion methods set out in Evaluation Methods below;
sustainable starting materials;
oil and grease resistance;
acid resistance; and
easily separable in a paper/card recycling process.

Combinations of the above properties are desirable, and a material or coating may be comparatively poor in one aspect, but have excellent properties in another aspect. For example, a material or coating may have only adequate water/oxygen barrier properties, but is able to be formed into a very thin material or coating, making it particularly advantageous for certain applications.

It should be noted that in the context of the present application, when referring to a range of between about “AA” and about “BB”, the point values of AA and BB are intended to be included as possible values in the range.

The word “comprise”, and variations such as “comprises” and “comprising” as used herein should be understood to mean the inclusion of the stated integer, step, group of integers or group of steps, but not to the exclusion of any other integer, step, groups of integers or group of steps.

The word “consisting of” as used herein limits the scope of the integer, step, group of integers or group of steps to the specified integer, step, groups of integers or group of steps. The word “consisting essentially of” as used herein limits the scope of the integer, step, group of integers or group of steps, and further integers, steps, groups of integers or groups of steps that do not materially affect the basic and novel characteristics of the invention.

The invention embraces all combinations of indicated integers, steps, groups of integers or groups of steps recited above. All patents and patent applications referred to herein are incorporated by reference in their entirety.

### ABBREVIATIONS

BHA butylated hydroxyanisole
BHT butylated hydroxytoluene
Dalton
DMAP 4-dimethylaminopyridine
DMSO dimethylsulfoxide
EDCI 1-ethyl-3-(3-dimethylaminopropyl)carbodiimide
FTIR Fourier-transform infrared
LDPE low-density polyethylene
LWP liquid water permeability
OTR oxygen transmission rate
PE polyethylene
PET polyethylene terephthalate
PLA polylactic acid
PP polypropylene
PTFE polytetrafluoroethylene
THF tetrahydrofuran
TPS thermoplastic starch
WVTR water vapour transmission rate

### EXAMPLES

### Chemicals

Agar (technical grade and biological grade), sodium alginate, pyridine and glycerol were purchased from Fisher Scientific. Acyl chlorides used were purchased form Tokyo Chemicals Industry UK Ltd or Fisher Scientific. Soybean oil was purchased from Sigma Aldrich.

### Evaluation Methods

### Layer and Material Thickness

The individual films (i.e. layers (A) and/or (B)) are generated and then the thickness of each film is measured using a micrometer screw gauge. When the films are layered and adhered together to form the composite material, the total thickness of the composite material is measured again using a micrometer screw gauge. For coatings, the substrate thickness is measured beforehand using a micrometer screw gauge. The coating is then applied to the substrate and the total thickness of the coated substrate is measured using a micrometer screw gauge. The coating thickness (i.e the thickness of the material or individual film) is calculated as the difference between the total thickness and the substrate thickness.

### Liquid Water Permeability (LWP)

The liquid water permeability is tested by placing a drop of water on the material being tested, and visually checking if any water is permeating through over time (at least 72 hours).

### Water Vapour Transmission Rate (WVTR)

Water vapour transmission rate describes the rate at which water vapour can pass through a material such as a film or a coating and is determined using an in-house method according to standard ASTM E96. Whereby, a vial is half-filled with deionised water and the film or coating is affixed over the open end of the vial. The assembly is weighed at the start of the test, and periodically throughout the test period. Over the course of the test the assembly is stored in a controlled environment to maintain a constant water vapour gradient. Loss in mass (g) is plotted as a function of time (hours), and a straight line of least-squares regression is drawn through the points. WVTR can be calculated as g/m²/d (wherein d=day i.e. 24 hours).

### Oxygen Transmission Rate (OTR)

Oxygen transmission rate describes the rate at which oxygen can pass through a material such as a film or coating and is determined using an in-house method according to according to standard ASTM D3985-17. Whereby, a circular test sample is loaded into a membrane permeability test cell, and residual gas is removed from the test rig by a vacuum pump. Test-rig pressure is recorded by data logging software and an electronic pressure transmitter. Once the baseline vacuum pressure is maintained, oxygen is introduced at a fixed pressure on one side of the test article. The pressure on the other side is logged with time. From the linear rate of pressure increase the OTR can be determined as cm³/m²/d (wherein d=day i.e. 24 hours).

### Cobb Test

This method describes a procedure for determining the quantity of water absorbed by non-bibulous or coated paper-based materials (Cobb value g/m²). Whereby, a circular test sample is weighed (g) and affixed to a Payne cup containing 1 cm of water. The Payne cup is inverted, and the test sample is uniformly wetted for 180 seconds. After 180 seconds the test specimen is removed and blotted to remove surface water. The specimen is immediately weighed again. The Cobb value is calculated as the weight of the water absorbed in g/m².

### Degradability in Soil Environment

Individual films (of layer (A), layer (B) or composite material), with or without additives such as plasticizers, were placed in a non-degradable PE plastic frame. The framed films were photographed and weighed, and then buried in a soil environment. The framed films were dug up every 2 weeks to measure their weight loss and check their visual appearance by taking photographs. Full degradability is determined as more than 90% of the film area having disappeared by visual comparison with the starting material.

### Anaerobic Digestion

Anaerobic digestion is carried out as described in the protocols of Angelidaki et al. (2009), Holliger et al. (2016), and Shrestha et al. (2020). Briefly, material (test polymer material or control material) is first assessed for volatile solids content (VS %). Then 1 litre bottles are used as reactor vessels and filled to maximum of 400 mL where a ratio of >4:1 in terms of VS in the inoculum (anaerobic digestion sludge collected from local authority site) and material is maintained to avoid problems of media acidification from the decomposition of organic matter. Comparison across different materials is made by maintaining the same total initial VS % in each vessel, which is determined to be between 20-60 gvs % Lₘᵢₓₜᵤᵣₑ⁻¹.

Reactor vessels are purged with flowing nitrogen to ensure anaerobic conditions. Anaerobic digestion reactor vessels are incubated in an oscillating water bath at 70 rpm and 35° C., and off gas from each reactor is collected in an up-turned volumetric cylinder filled with water. Gas volumes are recorded periodically.

### FTIR

Infrared (FTIR) spectra were recorded on a Perkin Elmer Frontier FT-IR instrument equipped with a zinc selenide crystal ATR module. Each spectrum was recorded with 8 scans between 4,000 and 400 cm⁻¹, with a resolution of 4 cm⁻¹.

### General Method A—Preparation of a Fatty Acid Ester Functionalised Polysaccharide Using a Fatty Acid Acyl Chloride

The polysaccharide used for layer (A) (first polysaccharide) is suspended in room temperature pyridine at approximately 6% w/v in a round-bottomed flask with mechanical stirring. A predetermined molar equivalent (3-7 equivalents relative to first polysaccharide repeat unit) of a selected fatty acid acyl chloride is added to the first polysaccharide-pyridine mixture, preferably by slow addition (e.g. dropwise addition) to control the exotherm. A condenser is fitted and the temperature of the reaction mixture is raised to 80-115° C. Stirring of the reaction mixture is maintained for 1-6 hr. After completion of the reaction, the reaction mixture is decanted into 5 volumes of room temperature ethanol to quench the reaction. The fatty acid ester functionalised polysaccharide solid composition is recovered by filtration and washed with hot ethanol to remove pyridine, pyridine hydrochloride, unreacted fatty acid acyl chloride and fatty acid by-product. The fatty acid ester functionalised polysaccharide solid composition is subsequently dried in a laboratory oven overnight, then recovered and stored in a glass vial for later analysis. Functionalisation and purity are confirmed by FTIR analysis of the fatty acid ester functionalised polysaccharide solid composition, as set out in Evaluation Methods.

### General Method B-1—Forming Layer (A) by Extrusion

Fatty acid ester functionalised first polysaccharide (e.g. obtained using General Method A) is optionally mixed with one or more additives (such as a plasticiser) to provide a fatty acid ester functionalised polysaccharide composition (layer (A)). If used, the fatty acid ester functionalised polysaccharide composition may be mixed with the selected one or more additives, for example by using a Haake Minilab II micro-compounding twin-screw extruder (20-150 rpm, 40-150° C.). The fatty acid ester functionalised polysaccharide composition and additive(s) are internally recirculated within the extruder to ensure thorough mixing. Prior to loading any materials into the extruder, a zero-load calibration is performed at operating temperature to normalise the screw torque measurements with respect to the frictional drag, at low (e.g. 20 rpm) and high (e.g. 170 rpm) rotation speeds. After completion of the mixing phase with additive, where required, key extruder operating parameters (extruder screw motor torque, screw rotational speed, heating block temperature, inlet and outlet pressure of the internal recirculation channel) are recorded over time (e.g. at 0.5 second intervals by use of serial data acquisition script written in Python). Motive power (the power required to convey the material within the extruder) is calculated:

$$P = τ \times ω$$

$$ω = \frac{2 π \times n}{60}$$

Where P is the motive power (Watts), τ is the screw torque (Nm), ω is the angular velocity (rad s⁻¹), and n is the screw rotation speed (rpm).

### General Method B-2—Forming Layer (A) by Hot Pressing

Fatty acid ester functionalised first polysaccharide (e.g. obtained using General Method A) is optionally mixed with one or more additives (e.g. plasticisers) to provide a fatty acid ester functionalised polysaccharide composition (layer (A)). The mixing process is conducted by thoroughly mixing together the functionalised first polysaccharide and the additives, for example by grinding with a pestle and mortar, or through other suitable mechanical mixing techniques. The solid is then subjected to heat and pressure in order to form layer (A). Typically, the solid is spread between two PTFE sheets which are placed between two metal plates, which are inserted in a thermopress and pressed at a suitable temperature (e.g. 150-180° C.) and pressure (e.g. around 10 bar) for a suitable time.

### General Method Y-1—Preparing a Solution of Material (B) for Solvent Casting

The un-derivatised second polysaccharide is dissolved in deionised water; the mixture is heated (e.g. at around 70° C.) under vigorous stirring until homogeneous and transparent. Quantities are adjusted to obtain the desired concentration (e.g. 0.5 to 12% w/v, such as 0.5 to 4% w/v). Optionally, a desired amount of additive or mixture of additives is added to the solution at this stage.

### General Method Y-2—Preparing a Solution/Dispersion of Material (A) for Solvent Casting

The fatty acid ester functionalised first polysaccharide (e.g. obtained using General Method A) and a suitable solvent are vigorously mixed by means of magnetic or mechanical stirring at room temperature for an appropriate length of time (e.g. 1-24 hrs). Suitable solvent(s) may be selected among esters (ethyl acetate, ethyl propanoate, ethyl butylate, propyl propanoate, butyl butylate, isobutyl butylate, 2-ethoxyethylacetate), ketones (acetone, 2-butanone, 2-pentanone, 3-pentanone, 4-methyl-2-pentanone, 4-heptanone), ethers (tetrahydrofuran, 2-methyltetrahydrofuran, ethylene glycol dimethyl ether, methyl tert-butyl ether), aromatics (benzene, toluene, xylenes, propylbenzene, p-cymene, pyridine), chlorinated (dichloromethane, chloroform), DMSO and N-methyl morpholine, or a mixture thereof. An additive (such as a plasticiser) or mixture of additives may be added if required. The concentration of material A in the final mixture is selected depending on the solvent(s) chosen and the intended application; typically 5 to 40% w/v is used. The mixture is stored in a sealed container and vigorously stirred again before being used.

### General Method C-1—Forming Layer (B) or Layer (A) by Solvent Casting

The material (B) solution, prepared according to General method Y-1, or the material (A) solution/dispersion, prepared according to General method Y-2, is cast into an evaporation dish or cast onto a suitable surface (e.g. PTFE sheet, Mylar sheet, polished glass or metal plate) by suitable means such as doctor blade coating, bar coating, spiral wire bar coating, brush coating or spray coating. The film is then left to dry in a well-ventilated area at a suitable temperature (e.g. fume cupboard, laboratory oven).

### General Method C-2—Forming Layer (B) Via Further Conversion of an Alginate Salt Film

Film formation using an alginate salt such as sodium alginate, calcium alginate or potassium alginate is carried out according to General Method C-1. Further conversion of these films to alginic acid films is carried out by applying an aqueous acid solution, e.g. 0.1 M HCl, onto the (B) layer by means of brushing, dipping or spraying. After treatment the films are rinsed with deionised water, blotted and then left to dry at ambient conditions. Further conversion of a sodium alginate film to a calcium alginate film is carried out by applying an aqueous calcium ions solution, typically calcium chloride, e.g. 3% w/v, onto the (B) layer by means of brushing, dipping or spraying. After treatment the films are rinsed with deionised water and then left to dry at ambient conditions. Optionally the films can then be further infused with one or more additives (such as a plasticiser) by submerging them in an aqueous solution of the desired additives, or alternatively in the pure additive(s) if liquid, for a suitable time. After treatment the films are blotted and left to dry at ambient conditions.

### General Method W—Solvent Casting for Composite and Coating Production

A solution/dispersion prepared according to General method Y-1 or Y-2 is prepared, ready for coating a second material. The second material used for such composite may be a self-standing layer (e.g. a film) produced from material (A) or material (B) (according to General Methods B-1, B-2, C1 or C2, respectively), to form for example composite material AB/BA; or a composite of said materials to form a multilayer composite, for example composite material ABA, BAB, ABAB etc. Alternatively, the second material can be a substrate such as a carbohydrate-based support (S), for forming for example coated substrates SB and SA. If the substrate already comprises one or more coating layers, substrates coated with composite material can be formed, for example SBA, SAB, BSB, ASA, SBABA (forming further coating layers in situ). The second material is coated with the solution/dispersion by means of doctor blade coating, bar coating, spiral wire bar coating, brush coating, spray coating, dip coating, curtain coating, spin coating or by roll coating. One or multiple layers of the same mixture may be applied. The composite material is then left to dry in a well-ventilated area at a suitable temperature (e.g. fume cupboard, laboratory oven).

General Method D-1—Forming a Composite Material with Arrangement ABA by Hot Pressing

Formation of composite films is carried out by layering the individual films, which were produced according to General Methods B-1, B-2, Y-1, Y-2, C-1 and/or C-2, on top of each other forming an ABA structure. The layers are then placed between two PTFE sheets which are placed between two stainless steel plates. The plates are placed in a thermopress and pressed at a suitable temperature (e.g. around 120-150° C.) and pressure (e.g. around 10 bar).

This method is suitable for alternative arrangements of composite material, e.g. AB, BAB, ABAB etc. Layering of the films can also be carried out by placing an adhesive layer between the individual film layers.

General Method D-2—Forming a Composite Material with Arrangement AB—In Situ

A self-standing material (B) film, manufactured according to General Method C-1 or C-2, is coated with a layer of material (A) by means of solvent casting according to General Method W, using a solution/dispersion of material (A) prepared according to General Method Y-2.

General Method X-1—Forming a Coated Substrate with Arrangement SB In Situ

A carbohydrate-based substrate S is coated with a layer of material (B) by means of solvent casting according to General Method W, using a solution of material (B) prepared according to General Method Y-1. Optionally, if the un-derivatized polysaccharide layer (B) is sodium alginate, further conversion to alginic acid can be achieved by applying an aqueous acid solution, e.g. 0.1 M HCl, onto the (B) layer by means of brushing, dipping or spraying. After the acid treatment, the (B) layer side of the coated substrate is rinsed with deionised water, blotted and then left to dry at suitable temperatures (e.g. room temperature). Alternatively, sodium alginate in layer (B) can optionally be converted to calcium alginate by applying an aqueous calcium ions solution, typically calcium chloride, e.g. 3% w/v, onto the (B) layer by means of brushing, dipping or spraying. After the treatment, the (B) layer side of the coated substrate is rinsed with deionised water, blotted and then left to dry at suitable temperatures (e.g. room temperature).

General Method X-2—Forming a Coated Substrate with Arrangement SA In Situ

A carbohydrate-based substrate S is coated with a layer of material (A) by means of solvent casting according to General method W, using a solution/dispersion of material (A) prepared according to General method Y-2.

General Method X-3—Forming a Coated Substrate with Arrangement SA by Hot Pressing—using preformed layer (A)

A carbohydrate-based substrate S is coated with a layer of material (A) which has been prepared according to General method B-2. Layer (A) and the substrate are placed between two PTFE sheets which are placed between two stainless steel plates. The plates are placed in a thermopress and pressed at a suitable temperature (e.g. around 120° C.) and pressure (e.g. around 5 bar).

General Method E-1—Forming a Coated Substrate with Arrangement SABA by Hot Pressing—Using Preformed Composite Material ABA

A carbohydrate-based substrate S is coated with a composite material (a film) to form a coated substrate with arrangement SABA. Firstly, an ABA composite film is produced according to General method D-1. The ABA film and the substrate are placed between two PTFE sheets which are placed between two stainless steel plates. The plates are placed in a thermopress and pressed at a suitable temperature (e.g. around 120° C.) and pressure (e.g. around 5 bar).

General Method E-2—Forming a Coated Substrate with Arrangement SBA—In Situ

A composite material with arrangement SBA is manufactured in situ by firstly producing an SB-type composite in accordance to General Method X-1, and secondly by coating that with a layer of material (A) by means of solvent casting according to General Method W, using a solution/dispersion of material (A) prepared according to General Method Y-2.

General Method E-3—Forming a Coated Substrate with Arrangement SBA—Mixed in Situ Formation of SB Following by Hot Pressing to Form SBA

A coated substrate with arrangement SBA is manufactured with a mixed method. Firstly, an SB-type composite is produced according to General Method X-1 (where layer (B) is formed in situ). Secondly, a preformed film of material (A) (produced according to General Method B-1 or B-2) is layered on top of layer (B), the substrate is placed between two PTFE sheets. These are placed between two stainless steel plates and pressed in a thermopress at a suitable temperature (e.g. around 120° C.) and pressure (e.g. around 10 bar). Alternative application methods of coatings are discussed in the description hereinabove, and include co-extrusion and roll coating. Alternatively, layering can be carried out by placing an adhesive layer between the substrate/material layers.

### Example 1: Preparation of Agar Functionalised with Palmitic Acid Chains According to General Method A

Pre-dried (50° C. overnight) agar (50 g) is loaded into a round bottom flask and suspended in pyridine (750 mL) at room temperature by means of mechanical stirring. Palmitoyl chloride (5.0 molar equivalents vs. polymer repeat unit, 250 mL) is slowly added under vigorous stirring, then the mixture is brought to a temperature of 105° C. and left to react for 3 hours under stirring. The mixture is then precipitated into ethanol (5 volumes), filtered under reduced pressure, and the solid washed with hot ethanol until running clear. The resulting solid is dried in an oven at 40-60° C. overnight. FTIR analysis is used to confirm the formation of the desired ester product (new peak at ca. 1742 cm⁻¹) and its purity (absence of palmitoyl chloride and palmitic acid peaks at ca. 1800 and 1698 cm⁻¹, respectively). FIG. 8 shows the FTIR spectrum of agar palmitate obtained as per Example 1, overlayed with spectra for agar and palmitic acid.

### Example 2a: Preparation of Layer (A) Comprising Agar Functionalised with Palmitic Acid Using Hot Pressing According to General Method B-2

The functionalised polysaccharide (agar functionalised with palmitic acid) prepared according to Example 1 was thinly spread between two PTFE sheets which are placed between two stainless steel plates. The plates were placed in a thermopress and pressed at 180° C. and 10 bar for 10 minutes.

### Example 2b: Preparation of Layer (A) Comprising Agar Functionalised with Palmitic Acid And Soybean Oil Additive Using Hot Pressing According to General Method B-2

The functionalised polysaccharide (agar functionalised with palmitic acid), prepared according to Example 1, and 20 wt % soybean oil were mixed by grinding them together in a pestle and mortar. The mixture was then thinly spread between two PTFE sheets which are placed between two stainless steel plates. The plates were placed in a thermopress and pressed at 180° C. and 10 bar for 10 minutes.

### Example 3a: Preparation of Layer (B) Comprising Sodium Alginate Using Solvent Casting According to General Methods Y-1 and C-1

Deionised water (100 mL) was placed in an Erlenmeyer flask and sodium alginate (1 g) was added under vigorous stirring. The mixture was heated to 70° C. for 30 minutes until full dissolution of sodium alginate was achieved. The solution was then poured into an evaporation dish and the water was evaporated in the oven at 50° C. overnight.

### Example 3b: Preparation of Layer (B) Comprising Sodium Alginate and Glycerol Using Solvent Casting According to General Methods Y-1 and C-1

Deionised water (100 mL) was placed in an Erlenmeyer flask, sodium alginate (1 g) and glycerol (0.8 g) were added under vigorous stirring. The mixture was heated to 70° C. for 30 minutes until full dissolution of sodium alginate was achieved. The solution was then poured into an evaporation dish and the water was evaporated in the oven at 50° C. overnight.

### Example 3c: Preparation of Layer (B) Comprising Alginic Acid and Glycerol Using Solvent Casting According to General Methods Y-1 and C-2

Deionised water (100 mL) was placed in an Erlenmeyer flask, sodium alginate (1 g) and glycerol (0.4 g) were added under vigorous stirring. The mixture was heated to 70° C. for 30 minutes until full dissolution of sodium alginate was achieved. The solution was then poured into an evaporation dish and the water was evaporated in the oven at 50° C. overnight. The obtained film was then placed into a 0.1 M HCl solution for 5 minutes. The film was rinsed with deionised water, blotted and then left to dry at ambient conditions. The film was then placed in glycerol for 5 minutes. After treatment the film was blotted and left to dry at ambient conditions.

### Example 3d: Preparation of Layer (B) Comprising Alginic Acid Using Solvent Casting According to General Methods Y-1 and C-2

Deionised water (100 mL) was placed in an Erlenmeyer flask, sodium alginate (1 g) was added under vigorous stirring. The mixture was heated to 70° C. for 30 minutes until full dissolution of sodium alginate was achieved. The solution was then poured into an evaporation dish and the water was evaporated in the oven at 50° C. overnight. The obtained film was then placed into a 0.1 M HCl solution for 5 minutes. The film was rinsed with deionised water, blotted and then left to dry at ambient conditions.

### Example 4: Preparation of Composite Film with Arrangement ABA Using Hot Pressing According to General Method D-1

Two individual films (A), prepared according to Example 2b, and one individual film (B), prepared according to Example 3c, were placed on top of each other forming an ABA structure. The layers were then placed between two PTFE sheets which were placed between two stainless steel plates. The plates were placed in a thermopress and pressed at 120° C. and 5 bar pressure for 5 minutes.

### Example 5—Forming a Composite Film with Arrangement AB In Situ According to General Method D-2

Individual film (B) was prepared according to Example 3c. A solution/dispersion of the palmitate-functionalised agar was produced by loading palmitate-functionalised agar (12.5 g; prepared according to Example 1) and toluene (100 mL) into a glass vial, which was sealed and magnetically stirred at room temperature overnight. The functionalised polysaccharide dispersion was applied to film (B) by brushing on the dispersion with a brush and allowing to dry at room temperature in a fume cupboard.

### Example 6a—Forming a Coated Substrate with Arrangement SB In Situ According to General Method X-1 (Using Brush Coating)

Deionised water (100 mL) was placed in an Erlenmeyer flask and sodium alginate (1 g) was added with vigorous stirring. The mixture was heated to 70° C. for 30 minutes until full dissolution of sodium alginate was achieved. The sodium alginate solution was applied to a paper or card substrate by brushing it on with a brush. The coated substrate was allowed to dry under ambient conditions. Once dry, 0.1 M HCl was applied to the coating using a transfer pipette and rinsed off with deionised water and allowed to dry under ambient conditions. The process of applying sodium alginate and subsequent treatment with acid was then repeated to ensure complete coverage of the substrate.

### Example 6a-2—Forming a Coated Substrate with Arrangement SB In Situ According to General Method X-1 (Using Spray Coating)

Deionised water (1000 mL) was placed in an Erlenmeyer flask and sodium alginate (40 g) and glycerol (20 g) were added under vigorous stirring. The mixture was heated to 70° C. for 30 minutes until full dissolution of sodium alginate was achieved. The solution was used to coat a paper or card substrate by placing it in a nitrogen pressurised high volume low pressure ColdShine Mini Spray Gun and spraying it onto the substrate until the surface was entirely covered and the desired thickness was obtained. The coated substrate was allowed to dry under ambient conditions.

### Example 6a-3—Forming a Coated Substrate with Arrangement SB In Situ According to General Method X-1 (Using Doctor Blade Coating)

Deionised water (1000 mL) was placed in an Erlenmeyer flask and sodium alginate (80 g) and glycerol (40 g) were added under vigorous stirring. The mixture was heated to 70° C. for 30 minutes until full dissolution of sodium alginate was achieved. The dispersion was used to coat a paper or card substrate by means of a motorised blade coater instrument using a micrometer-adjustable doctor blade. The substrate was laid flat onto the instrument, the blade gap was adjusted to 400 μm, the solution was poured onto the substrate, and the motor was activated at 30 mm/s speed. The coated substrate was allowed to dry under ambient conditions. Once dry, 0.1 M HCl was applied to the coating using a transfer pipette, rinsed off with deionised water and allowed to dry under ambient conditions.

### Example 6b—Forming a Coated Substrate with Arrangement SA In Situ According to General Method X-2 (Using Doctor Blade Coating)

Palmitate-functionalised agar (12.5 g, prepared according to Example 1) and toluene (100 mL) were loaded into a glass vial, which was sealed and magnetically stirred at room temperature overnight. The dispersion was used to coat a paper or card substrate by means of a motorised blade coater instrument using a micrometer-adjustable doctor blade. The substrate was laid flat onto the instrument, the blade gap was adjusted to 600 μm, the agar palmitate dispersion was poured onto the substrate, and the motor was activated at 30 mm/s speed. The coated substrate was then allowed to dry in a fume cupboard at room temperature. The process was repeated using 15.0 g of palmitate-functionalised agar (prepared according to Example 1) and 100 mL of ethyl propanoate as solvent.

### Example 6c—Forming a Coated Substrate with Arrangement SA In Situ According to General Method X-2 (Using Brush Coating)

Palmitate-functionalised agar (12.5 g, prepared according to Example 1) and toluene (100 mL) were loaded into a glass vial, which was sealed and magnetically stirred at room temperature overnight. The dispersion was used to coat a paper or card substrate by brushing it on with a brush until the surface was entirely covered. The coated substrate was then allowed to dry in a fume cupboard at room temperature.

### Example 6d—Forming a Coated Substrate with Arrangement SA In Situ According to General Method X-2 (Using Spray Coating)

Palmitate-functionalised agar (12.5 g, prepared according to Example 1) and toluene (100 mL) were loaded into a glass vial, which was sealed and magnetically stirred at room temperature overnight. The dispersion was used to coat a 3D shaped dry moulded fibre bowl by placing it in a nitrogen pressurised high volume low pressure ColdShine Mini Spray Gun and spraying it onto the inner bowl surface until the surface was entirely covered and the desired thickness was obtained. The coated substrate was then allowed to dry in a fume cupboard at room temperature. The process was repeated using 9.0 g of palmitate-functionalised agar (prepared according to Example 1) and 3-pentanone as solvent.

### Example 7a—Forming a Coated Substrate with Arrangement SA Using Hot Pressing (Using Pre-Formed Layer (A)) According to General Method X-3

Individual film (A) prepared according to Example 2a and a paper or card substrate were placed on top of each other to form an SA structure. The layers were then placed between two PTFE sheets which were placed between two stainless steel plates. The plates were placed in a thermopress and pressed at 120° C. and 5 bar pressure for 5 minutes.

### Example 7b: Preparation of Coated Substrate with Arrangement SABA Using Hot Pressing (Using Preformed Composite Film ABA)

Individual ABA film prepared according to Example 4, and substrate S (paper or card) were placed on top of each other forming a SABA structure. The layers were then placed between two PTFE sheets which were placed between two stainless steel plates. The plates were placed in a thermopress and pressed at 120° C. and 5 bar pressure for 5 minutes.

### Example 8: Preparation of Coated Substrate with Arrangement SBA Using Solvent Casting (Using Preformed Layer (B), Formed In Situ)

Firstly, paper or card substrate S was coated with a layer of (B) in situ according to Example 6a to yield a material with the structure SB. A solution/dispersion of palmitate-functionalised agar (12.5 g, prepared according to Example 1) and toluene (100 mL) were loaded into a glass vial, which was sealed and magnetically stirred at room temperature overnight. Once thoroughly combined, dispersion A was applied to the substrate SB by brushing it on with a brush, forming the structure SBA. The coating was allowed to dry at room temperature in a fume cupboard.

### Example 9: Preparation of Coated Substate with Arrangement SBA Using Hot Pressing (Using Preformed Layer (A) and Preformed Layer (B))

Firstly, paper or card substrate S was coated with a layer of (B) according to Example 6a to yield a material with the structure SB. Individual film (A) was prepared according to Example 2a. The layers SB and film A were positioned on top of each other to yield the structure SBA. The layers were then placed between two PTFE sheets which were placed between two stainless steel plates. The plates were placed in a thermopress and pressed at 120° C. and 5 bar pressure for 5 minutes.

### Example 10: Evaluation of Individual Layers A and B, Composite Material ABA, and Coated Substates with SA, SB or SBA Structure

Thickness, liquid water permeability, water vapour transmission, oxygen transmission rate and Cobb value for composite film ABA (prepared according to Example 4) and coated paper substrate SBA (prepared according to Example 9) were evaluated as set out in the Evaluation Methods. Individual layers A (prepared according to Example 2a) and B (prepared according to Example 3a) were also evaluated, and substrates coated separately with layer A (SA with the substrate being paper, prepared according to Example 7a) and with layer B (SB with the substrate being paper, prepared according to Example 6a). The results are summarised in Table 1 below.

TABLE 1
Parameter evaluation for individual layers (A) and (B), composite
film ABA, coated substrate with arrangement SA, coated substrate
with arrangement SB and coated substrate with arrangement SBA
(substrate in each case is paper, with thickness 0.100 mm).

| | Thickness | | | | |
|---|---|---|---|---|---|
| | including | | | | |
| | substrate | Liquid water | WVTR | OTR | Cobb |
| Material | (mm) | permeability | (g/m²/d) | (cm³/m²/d) | (g/m²) |
| Layer A | 0.200 | None | 19 | 166 | N/A |
| Layer B | 0.020 | 7 min | 607 | 31 | N/A |
| | | breakthrough | | | |
| | | time | | | |
| ABA | 0.313 | None | 14 | 11 | N/A |
| SA | 0.220 | None | 80 | 62 | 2.4 |
| SB | 0.107 | 7 min | 699 | 183 | 68 |
| | | breakthrough | | | |
| | | time | | | |
| SBA | 0.481 | none | 49 | 54 | 1.5 |

Comparing individual layers (A) and (B), it can be seen that layer (A) exhibited excellent water barrier properties (as evidenced by having no liquid water permeability, and a relatively low WVTR value) but relatively poor oxygen barrier properties (as evidenced by the relatively high OTR value). Conversely, layer (B) exhibited excellent oxygen barrier properties, but relatively poor water barrier properties. The composite film ABA exhibited improved water and oxygen barrier properties, compared to the layers individually. Comparing the paper substrate coated with layer (A) (SA) with the paper substrate coated with layer (B) (SB), material SA outperformed SB in terms of both water and oxygen barrier properties. However, paper coated with a composite layer BA outperformed material SA, exhibiting even lower WVTR and OTR values.

By varying the thickness of the materials, a further reduction of WVTR and OTR values can be achieved as these values are directly correlated to the thickness of the material, as explained in Example 13.

### Example 11: Degradability Study of Layers (A) and (B)

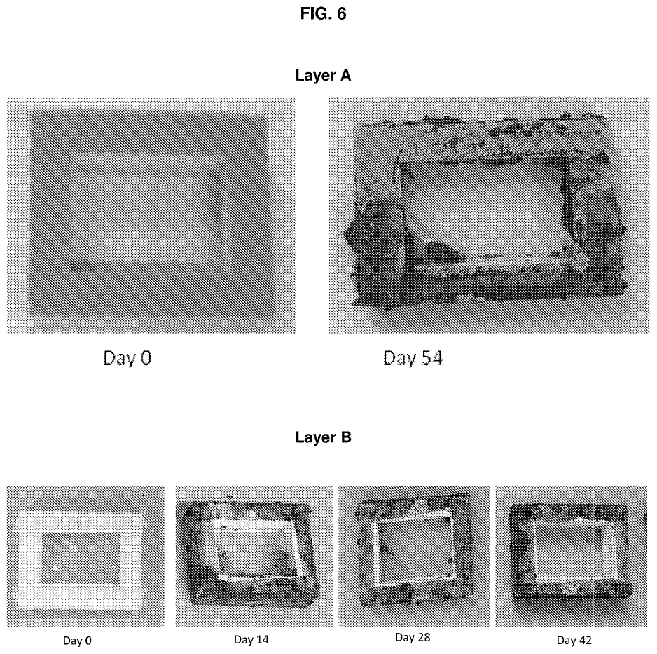

The degradability in soil of individual layers (A) and (B) (prepared according to Examples 2b and 3c, respectively) was tested using the method set out in Evaluation Methods above. The results are shown in FIG. 6, where it can be seen that both layers exhibited significant degradation over a relatively short time period.

### Example 12: Anaerobic Digestion Study

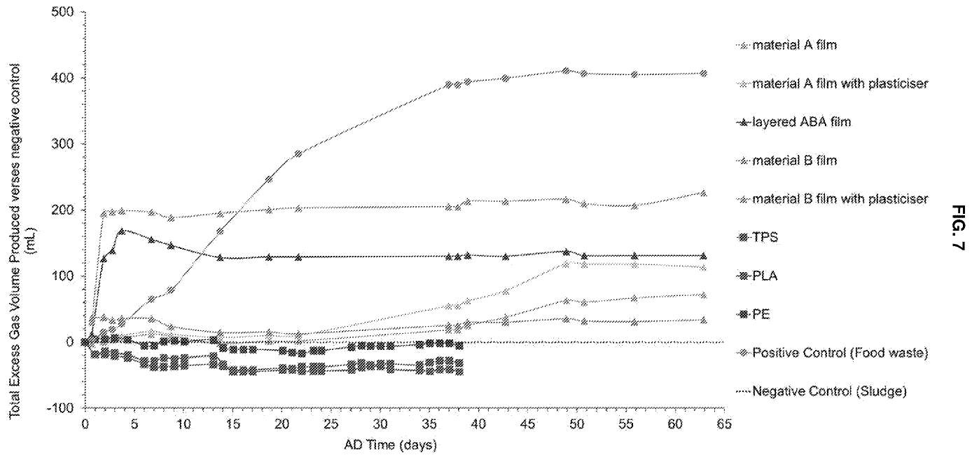

Individual layers (A) and (B), with and without plasticiser (prepared according to Example 2a, 2b, 3c, 3d, with 20 wt % soybean oil as the plasticizer for layer (A) and 20 wt % glycerol for layer B) and composite film ABA (prepared according to Example 4) were subjected to anaerobic digestion as described in the evaluation methods section. Known petroleum-derived plastics PE (polyethylene), and common bio-derived compostable polymers PLA (polylactic acid) and TPS (thermoplastic starch) were also tested as comparators. The results are shown in FIG. 7, where it can be seen that comparators PE, PLA and TPS produced no, or negative gas volumes, indicating no degradation. Layers (A) and (B) alone exhibited some degradation, which was enhanced when a plasticizer was included in the layer, as evidenced by the greater volumes of gas released. Interestingly, layered film ABA exhibited higher levels of anaerobic digestion that either of individual layers (A) and (B), which was not expected.

### Example 13: Further Examples of Composite Films ABA with Varying Thickness

Layer (A) in each case was formed using the method set out in Example 2b and contained agar functionalised with palmitic acid together with soybean oil (20 wt % for ABA1-6 and ABA8, 30 wt % for ABA7, 10 wt % for ABA9 and 5 wt % for ABA10) additive. Layer (B) in each case was formed using the method set out in Example 3c and contained alginic acid, together with glycerol (40 wt %) additive. The layering of the individual films to form the ABA structure was carried out according to Example 4. In each case, thickness, liquid water permeability, water vapour transmission rate and oxygen transmission rate were evaluated as set out in the Evaluation Methods. The results are summarised in Table 2 below.

TABLE 2
Parameter evaluation for composite films ABA of varying thickness

| | | Thickness | Total film | | | |
|---|---|---|---|---|---|---|
| Composite film | | layer B | thickness | | WVTR | OTR |
| ABA | Thickness layer A (mm) | (mm) | (mm) | LWP* | (g/m²/d) | (cm³/m²/d) |
| ABA1 | 0.124, 0.158 = 0.282 (total) | 0.030 | 0.301 | None | 14.19 | 35.52 |
| ABA2 | 0.154, 0.145 = 0.299 (total) | 0.056 | 0.267 | None | 11.59 | 27.53 |
| ABA3 | 0.145, 0.153 = 0.298 (total) | 0.094 | 0.313 | None | 14.20 | 13.19 |
| ABA4 | 0.146, 0.146 = 0.405 (total) | 0.059 | 0.232 | None | 22.20 | 31.39 |
| ABA5 | 0.289, 0.292 = 0.581 (total) | 0.059 | 0.420 | None | 13.08 | 42.92 |
| ABA6 | 0.405, 0.405 = 0.810 (total) | 0.060 | 0.732 | None | 7.25 | 30.72 |
| ABA7 | 0.121, 0.132 = 0.253 (total) | 0.067 | 0.238 | None | 35.42 | 41.00 |
| ABA8 | 0.152, 0.155 = 0.307 (total) | 0.063 | 0.294 | None | 19.29 | 15.00 |
| ABA9 | 0.140, 0.153 = 0.293 (total) | 0.062 | 0.311 | None | 14.99 | 19.00 |
| ABA10 | 0.154, 0.159 = 0.313 (total) | 0.062 | 0.331 | None | 14.33 | 11.00 |

*Liquid water permeability - breakthrough time

All ABA composite films exhibited good water barrier properties, with no water permeability being observed over the time period monitored. It can be observed that the values for the WVTR decrease with increasing thickness of layer (A), confirming that the modified polysaccharide layer (A) provides the main barrier against moisture. Lowering the amount of soybean oil plasticiser in layer (A) does also result in a reduction in WVTR. The OTR values decrease with increasing thickness of layer (B), confirming that the unmodified polysaccharide provides the main oxygen barrier. Furthermore, a reduction in plasticiser loading in layer (A) also facilitates a reduction in OTR.

### Example 14: Further Examples of Coated Substate with SBA Structure with Variations in Application of Layer (A) and Variations of Composition of Layer (B)

Coated card samples (0.400 mm thickness) with a coating of composite film (SBA) were prepared as set out in Example 8 (in situ) and Example 9 (mixed). Layer (A) in each case contained agar functionalised with palmitic acid. Layer (B) consisted of either sodium alginate or alginic acid. The results are summarised in Table 3 below.

TABLE 3
Parameter evaluation for SBA composite materials with variations in application
method of layer (A) (brush coated vs. hot pressed) and variations of composition of layer (B)
(sodium alginate vs. alginic acid)

| | | | | Total | | | |
|---|---|---|---|---|---|---|---|
| | Application | | | coating | | | |
| Coated | of | | Application | thickness | | WVTR | OTR |
| substrate | Layer A | Layer B | of Layer B | (mm) | LWP* | (g/m²/d) | (cm³/m²/d) |
| SBA1 | brush | sodium | brush | 0.025 | None | 360.00 | 36.02 |
| | coated | alginate | coated | | | | |
| SBA2 | brush | alginic acid | brush | 0.020 | None | 369.05 | not |
| | coated | | coated | | | | tested |
| SBA3 | hot pressed | sodium | brush | 0.151 | None | 28.41 | 27.73 |
| | | alginate | coated | | | | |
| SBA4 | hot pressed | alginic acid | brush | 0.240 | None | 5.50 | 29.49 |
| | | | coated | | | | |

* Liquid water permeability - breakthrough time

When comparing SBA1 with SBA2, it can be observed that the WVTR values are similar for sodium alginate as (B) layer and alginic acid as (B) layer. This is due to the moisture barrier stemming from layer (A) which is of similar thickness for both samples, as it was produced exactly in the same manner with the same application method (brush coating). A thicker layer (A), here obtained by hot pressing as application method (SBA3 and SBA4), leads to lower WVTR values compared to SBA1 and SBA2. OTR values are similar for all samples as layer (B), which is the main oxygen barrier, is obtained (here, via brush coating application) with similar thicknesses for all samples, i.e. around 0.007 mm.

### Overall Conclusion

Layer (A) films and substrates coated with layer (A) exhibited excellent water barrier properties (as evidenced by having no liquid water permeability, and low WVTR values). All ABA composite films and SBA coated substrates exhibited excellent water barrier properties, with no water permeability being observed over the time period monitored and low Cobb values, and also good oxygen barrier properties.

For applications where low WVTR is required, an increase in the thickness of layer (A), as demonstrated by film ABA6 (Table 2), can provide WVTR values as low as 7.25 g/m²/d. The same was observed for SBA coated substrates where thicker (A) layers (here applied via hot pressing) led to lower WVTR values (see SBA4, Table 3) compared to thinner (A) layers (here applied via brush coating).

For applications where low OTR values are required, composite films with a thick (B) layer, such as ABA3 (Table 2), are preferred. Composite material ABA10 (Table 2) gives the best overall performance taking both WVTR and OTR values into account.

### REFERENCES

The following publications cited in this application are herein incorporated by reference in their entirety.
Abdullah et al. Front. Nutr. 2022, 9:1000116.
Angelidaki et al. Water Science and Technology 2009, 59, no. 5, 927-34.
Cazón et al. Food Hydrocolloids 2017, 68, 136-148.
Diaz-Montez Polysaccharides 2022, 3, 480-501.
Ghiasi et al. Industrial Crops & Products 2020, 154, 112679.
Holliger et al. Water Science and Technology 2016, 74, no. 11, 2515-22.
Khalil et al. J. Appl. Polym. Sci. 2019, 136, 47251.
Kibar Journal of Food Process Engineering 2017, 40, e12382.
Shrestha et al. Sustainability 2020, 12, no. 10 4231.

1. A substrate with a surface having
a coating comprising a material, wherein the material of the coating comprises:
a layer (A comprising a polysaccharide which has been derivatised to comprise fatty acid ester moieties,
wherein the polysaccharide is derived from seaweed and is selected from the group consisting of agar, carrageenan, alginic acid, an alginate salt, fucoidan, laminarin, agarose, agaropectin and ulvan;
and wherein the substrate is or comprises a packaging material.

2. A substrate with a surface having
a coating comprising a material of the coating, wherein the material comprises:
a layer (B) comprising an un-derivatised polysaccharide.

3. A composite material comprising:
at least one layer (A) comprising a first polysaccharide which has been derivatised to comprise fatty acid ester moieties; and
at least one layer (B) comprising a second polysaccharide which is un-derivatised.

4. A substrate with a surface having a coating comprising the composite material according to claim 3.

5. A substrate according to claim 4, which is or comprises a packaging material.

6. A substrate according to claim 5, wherein the packaging material is a food packaging material, a beverage packaging material, a food supplement packaging material, a vitamin packaging material, a personal hygiene product packaging material, a cosmetic product packaging material, a product containing an active agent packaging material, or a cleaning product packaging material.

7. The composite material according to claim 3, wherein the first polysaccharide in the at least one layer (A) is selected from the group consisting of cellulose, starch, agar, carrageenan, alginic acid, an alginate salt including sodium alginate, calcium alginate or potassium alginate, fucoidan, laminarin, agarose, agaropectin, ulvan, xanthan gum and pectin.

8. (canceled)

9. The composite material according to claim 7, wherein the first polysaccharide in the at least one layer (A) is selected from the group consisting of cellulose, starch and agar.

10. The composite material according to claim 3, wherein the fatty acid ester moieties are of formula: —C(O)O(CH₂)₁₀₋₂₀CH₃ including —C(O)O(CH₂)₁₀₋₁₈CH₃.

11. (canceled)

12. The composite material according to claim 3, wherein the at least one layer (A) comprises an additive selected from the group consisting of a plasticiser, a filler, a surfactant, an antioxidant, er and a mixture thereof.

13-16. (canceled)

17. The composite material according to claim 3, wherein the second polysaccharide in the at least one layer (B) is selected from the group consisting of agar, alginic acid, an alginate salt including sodium alginate, calcium alginate or potassium alginate, carrageenan, cellulose, starch and xanthan gum.

18. (canceled)

19. The composite material according to claim 3, wherein at least a portion of a surface of the at least one layer (A) is in contact with at least a portion of a surface of the at least one layer (B).

20. The substrate or composite material according to claim 19, wherein substantially all or all of the surface of the at least one layer (A) is in contact with substantially all or all of the surface of the at least one layer (B).

21. (canceled)

22. (canceled)

23. (canceled)

24. The composite material according to claim 3, wherein the at least one layer (B) comprises an additive selected from the group consisting of a plasticiser, a filler, a surfactant, an antioxidant, and mixtures thereof.

25-34. (canceled)

35. The composite material according to claim 3, wherein the at least one layer (A) and the at least one layer (B) of the composite material comprises or consists of:
a single layer (A) comprising: the first polysaccharide which has been derivatised to comprise fatty acid ester moieties; and
a single layer (B) comprising: the second polysaccharide which is un-derivatised.

36. The composite material according to claim 35, wherein at least a portion of including substantially all or all of a surface of the single layer (A) is in contact with at least a portion of including substantially all or all of a surface of the single layer (B).

37. (canceled)

38. (canceled)

39. The substrate according to claim 1, wherein the substrate and the coating are biodegradable.

40. The substrate according to claim 1, wherein the substrate is or comprises a packaging material including a food packaging material, a beverage packaging material, a food supplement packaging material, a vitamin packaging material, a personal hygiene product packaging material, a cosmetic product packaging material, a product containing an active agent packaging material or a cleaning product packaging material.

41. The substrate according to claim 40, wherein the substrate is carbohydrate-based.

42. (canceled)

43. (canceled)

44. The substrate according to claim 1, wherein the substrate is selected from the group consisting of paper, cardboard, corrugated board, paperboard, carton board, fibre and fabric, and mixtures thereof.

45-59. (canceled)

60. The substrate according to claim 1, wherein the layer is a single layer.

61. (canceled)
